(19) United States
(12) Patent Application Publication
(10) Pub. No.: US 2026/0356501 A1
(43) Pub. Date: Nov. 12, 2026

(54) MANEUVERABILITY & ORIENTATION CONTROL SYSTEM FOR ARTIFICIAL INTELLIGENCE SATELLITE MODULE

(71) Applicant: Google LLC, Mountain View, CA (US)

(72) Inventors: Blaise Aguera-Arcas, Seattle, WA (US); Thomas Fischbacher, Zurich (CH); Travis Roland Beals, Bowen Island (CA)

(21) Appl. No.: 19/203,007

(22) Filed: May 8, 2025

(51) Int. Cl. B64G 1/24; H04B 10/118

(52) U.S. Cl. CPC B64G 1/247; H04B 10/118

(57) ABSTRACT

Methods, systems, and apparatus, including computational instructions/programs encoded on a computer-readable medium, are disclosed for implementing a maneuverability and orientation control system in a satellite module. The control system generates, by a first sensor, magnetic field values of an object external to the satellite module, and generates, by a second sensor, location information of the satellite relative to the object external to the satellite module. The control system computes, by a first predictive model, a first control output based on the magnetic field values and the location information. The control system controls an orbital state vector of the satellite module by adjusting a magnetic dipole force vector of the satellite module based on the first control output.

### BACKGROUND

This specification generally relates to computing hardware for machine learning and artificial intelligence applications.

The expansion and integration of artificial intelligence (AI) or machine learning (ML) in modern edge/cloud devices has increased demand for specialized computing resources that can efficiently execute AI/ML workloads at scale. Datacenters and cloud platforms that provide specialized computing hardware are often constrained by the bandwidth, resource overhead, and electrical power requirements for distributed execution of AI/ML workloads across largescale datacenters.

In general, AI/ML applications are implemented using machine-learning models and corresponding algorithms that are inherently software constructs. Interacting with AI tools and technology first requires that these software constructs be implemented or executed on the specialized computing hardware mentioned above. For example, these hardware resources include special-purpose integrated circuits configured to perform the large-scale matrix and vector computations that are fundamental to most ML models and algorithms. These special-purpose integrated circuits are commonly referred to as ML hardware accelerators and include proprietary AI/ML processors and matrix/vector units with compute architectures that are optimized for ML training, inference, or both.

The availability and rise of open-source code and other resources for implementing ML models will translate to increased demand for the special-purpose circuits that are optimized to implement the ML models and algorithms. As the demand for these AI/ML computing assets outpaces available capacity in existing data centers, new techniques and environments for implementing ML models on specialized computing hardware will be central to the growth and further development of AI/ML technologies.

### SUMMARY

This specification describes a system and method for a control system of a satellite module configured for artificial intelligence (AI) and/or machine learning (ML) computing in space. The satellite module can include sensors to capture sensor measurements including magnetic field values and location information of objects external to the satellite module. Examples of sensors can include accelerometers, gyroscopes, cameras and other optical sensors, among other types of sensors described in this specification. The control system can compute a control output based on the sensor measurements and using a model such as a predictive model and/or physics-based model. The control system controls an adjustment of an orbital state vector for the satellite module by adjusting a magnetic dipole force vector based on the computed control output. Adjustments to the orbital state vector for the satellite module can include adjustments to its orientation, orbital position vector, orbital velocity vector, orbital path, or some combination thereof. The orbital state vector is referred to alternatively herein as a “state vector.” Adjustment to the orbital state vector can be performed by adjusting an actively-generated magnetic field as one example of a propulsion system. Propulsion systems can include thrusters (e.g., chemical, ion, cold gas), reaction wheels, control moment gyroscopes, solar sails, magnetic dipole-dipole coupling between satellites, and other types of propulsion systems described in this specification.

The satellite module can be configured as a planar satellite and is referred to alternatively as a “satellite.” The satellite allows for AI/ML computing workloads to be implemented in space in a power-efficient manner by converting solar energy into electrical power and performing AI tasks, such as model training and/or inference. For example, the satellite can include a solar panel having multiple photovoltaic (or solar) cells that are used to generate power by converting solar energy to electrical energy for powering special-purpose integrated circuits and other electronic components of the satellite module. The special-purpose integrated circuits can include a set or layer of ML hardware accelerators configured to perform AI/ML workloads and tasks (individually or collectively), by using AI/ML models based on neural networks and other ML algorithms.

The disclosed control system can be configured for real-time or near-real time adjustments of orbits and maneuvers for satellites to improve solar energy collection and communication between multiple satellites. The orbital adjustments to improve inter-satellite communication allow for distributing tasks among the satellites based on current or expected allocations of computing bandwidth and resources. The satellite module also includes subsystems for propulsion, attitude control, communication (e.g., optical, radio frequency), and other types of satellite subsystems that support executing AI/ML workloads in space.

The disclosed control system can adjust the orientation and/or orbit of the satellite by generating and applying a magnetic dipole force vector, from generating control signals that control the adjustment of the state vector of the satellite. In some instances, the control signals can include generating a current at a particular value corresponding to the magnetic dipole force vector, alternatively referred to herein as “magnetic force vector.” As described in this specification, adjusting the magnetic dipole force can also include adjusting an actively-generated magnetic field of the satellite.

By generating a current corresponding to a particular amount of magnetic force, the control system generates a force or force vector that causes an adjustment to the orbital state, e.g., position, velocity, orientation, and/or orbit of the satellite. For instance, the magnetic force can result in a corresponding torque that adjusts the orientation of the satellite. Other adjustments determined by the disclosed control system can be implemented by reaction wheels, magnetorquers, thrusters, or some combination thereof, to adjust the state vector of the satellite. The state vector for the satellite can include state information such as the position, velocity, acceleration, and other types of orbital parameters for the satellite. Other examples of state information in a state vector can include orbital angles, attitude angles, and ground-based tracking angles.

The control system disclosed in this specification allows for precise, dynamic adjustments to the satellite state vector based on magnetic field measurements from magnetic fields of objects external to the satellite, such as spacecraft, other satellites/modules, a celestial body, or a system of celestial bodies. For example, the disclosed control system generates adjustments to state vectors that are based on sensor measurements and position information of objects external to the satellite module. In this way, the control system accounts for the effect of magnetic fields generated by external objects, such as celestial bodies and other satellites. As another example, the disclosed control system can also allow for efficient control and coordination of multiple satellites, also referred to as “swarm control.” The control system can provide state vector adjustments for multiple satellites that permit efficient communication between two or more satellites from the multiple satellites.

For example, the control system can configure the states of two or more satellites to achieve a precise physical connection between the two or more satellites. Each satellite can include a physical connector configured for data transmission and the disclosed control system can substantially align the satellites such that the physical connectors permit data transmission between the satellites. In another example, the control system can adjust the states of two or more satellites to achieve efficient free-space optical communication between the satellites. Each satellite can include an optical communication module configured for data transmission, e.g., using radio frequency communication, laser communication, etc. The optical communication module can include a lens and actuators configured to adjust orientations of the lens. The disclosed control system can adjust states of multiple satellites by configuring the multiple satellites to achieve a target orbit or set of orbits and/or maintain a target angle or set of target angles. In this way, the disclosed control system can allow for substantial alignment (e.g., position and orientation) between the optical communication modules of the satellites and thereby allow for free-space communication among a swarm of satellites.

One aspect of the subject matter described in this specification can be embodied in a control system for a satellite module. The satellite module includes a first sensor configured to generate magnetic field values of an object external to the satellite module, a second sensor configured to generate location information of the satellite relative to the object external to the satellite module, and a first predictive model configured to compute a first control output based on the magnetic field values and the location information. The control system is configured to control an adjustment of an orbital state vector of the satellite module by adjusting a magnetic dipole force vector of the satellite module based on the first control output.

In some implementations, the orbital state vector of the satellite module includes at least one of (i) an orbital position vector of the satellite module, and (ii) an orbital velocity vector of the satellite module.

In some implementations, the control system is configured to: deploy a solar sail of the satellite module based on the first control output, and adjust the orbital state vector of the satellite module using the solar sail, in response to deploying the solar sail.

In some implementations, the control system is configured to: configure a vectoring component of the control system based on a timing parameter and a control instruction indicated by the first control output, and perform the adjustment of the orbital state vector in response to configuring the vectoring component based on the timing parameter and the control instruction.

In some implementations, the control system is further configured to generate a first current signal that corresponds to an adjustment of the magnetic dipole force vector. The first current signal traverses a current loop path that is substantially parallel to a circumference of the satellite module. The vectoring component can include a reaction wheel and configuring the vectoring component can include configuring, using the first control output, the reaction wheel to spin at a speed corresponding to the adjustment of the magnetic dipole force vector.

In some implementations, the control system is configured to generate, by the control system, a second current signal. The control system can generate, using a magnetorquer and based on the second current signal, a counteracting magnetic dipole force vector. The control system can control an attitude of the satellite module by mitigating excess angular momentum of the satellite module based on the counteracting magnetic dipole force vector.

In some implementations, the first predictive model is a machine-learning (“ML”) inference model configured to: process an input dataset including magnetic field values and location information about objects external to the satellite module, generate control outputs based on ML inferences computed as outputs of the ML inference model in response to processing the input dataset, and dynamically adjust the orbital state vector of the satellite module based on the control outputs.

In some implementations, the control system is configured to: compute, by a physics-based model, a second control output based on a deterministic control algorithm of the physics-based model that receives the magnetic field values or the location information as inputs to the deterministic control algorithm. In some implementations, the physics-based model is configured to: i) process, using the deterministic control algorithm, on-board sensor data generated at the satellite module and image-based location information about objects external to the satellite module, and ii) compute a plurality of control outputs for adjusting the orbital state vector of the satellite module based on attitude estimations determined from processing the on-board sensor data and image-based location information.

In some implementations, the control system is configured to detect a difference between the first control output and the second control output in response to comparing the first and second control outputs. The control system is configured to, based on the detected difference, identify an inconsistency between respective orbital state vectors of the satellite module that correspond to the first and second control outputs. The control system is configured to adjust the orbital state vector of the satellite module based on prioritization logic that resolves the inconsistency in favor of control outputs computed by a particular model of the satellite module.

In some implementations, the control system is configured to: receive, from an external data source, data related to at least (i) the object external to the satellite module, or (ii) the satellite module, and compute, by the first predictive model of the control system, the first control output based on the external data. In some implementations, the satellite module is a first satellite module that communicates with a second satellite module. The control system is configured to: control the adjustment of the orbital state vector of the first satellite module by adjusting a magnetic dipole force vector of the first satellite module based on sensor data. The sensor data is i) generated at the second satellite module, and ii) processed by the first satellite module after being received from the second satellite module.

In some implementations, the first satellite module is part of a swarm including a plurality of other satellite modules. The control system is configured to: receive, by the first satellite module, sensor data generated by sensors integrated in at least one of the plurality of other satellite modules and compute, by an ML inference model of the first satellite module, a swarm control output based on the sensor data. The swarm control output includes control settings that are used to adjust a respective orbital state vector of the other satellite modules in the swarm. In some implementations, the satellite module is a planar, modular satellite configured for coupling to another planar, modular satellite. In some implementations, the first control output includes a predicted state vector for a particular time period for the satellite module based on data captured by the first sensor prior to the particular time period.

In some implementations, the control system includes a connector configured to communicatively couple the satellite module to a first satellite module different from the satellite module. In some implementations, the connector is a physical connector for connection to another physical connector of another satellite module. In some implementations, the connector is an optical inter-satellite connector that includes one or more actuators and a lens. The one or more actuators are configured to adjust an angle of the lens for free-space communication with another optical inter-satellite connector of another satellite module.

In some implementations, the satellite module includes a thruster subsystem. The control system is configured to adjust the magnetic force vector of the satellite by generating, using the thruster subsystem, an amount of thrust based on the control output. In some implementations, the first sensor includes one or more of a magnetometer, a magneto-resistive sensor, a vector sensor, and an inductive sensor. In some implementations, the second sensor includes one or more of a star-tracker sensor, a sun-tracker sensor, imaging sensor, camera, and a Global Positioning System (GPS) sensor.

In some implementations, adjusting the magnetic dipole force vector of the satellite module includes the control system being configured to: generate thrust by a directional thruster of the satellite module based on the first control output, and control the orbital state vector of the satellite module based on the thrust generated by the directional thruster.

In some implementations, the satellite module is part of a swarm including a plurality of satellite modules and the control system is configured to: control a respective orbital state vector of each satellite module in the swarm, configure a swarm formation orbit by adjusting a respective magnetic dipole force vector of at least one satellite module of the swarm, and adjust a configuration of the swarm formation orbit based on changes in magnetic field density of a celestial body orbited by the plurality of satellite modules of the swarm.

One aspect of the subject matter described in this specification can be embodied in a non-transitory machine-readable storage device storing instructions for control of a satellite module, the instructions being executable by a control system of the satellite module to cause performance of operations. The operations include generating, by a first sensor, magnetic field values of an object external to the satellite module. The operations include generating, by a second sensor, location information of the satellite relative to the object external to the satellite module. The operations include computing, by a first predictive model of the control system, a first control output based on the magnetic field values and the location information. The operations include controlling an orbital state vector of the satellite module by adjusting a magnetic dipole force vector of the satellite module based on the first control output.

These and other implementations can each optionally include one or more of the following features. In some implementations, the orbital state vector of the satellite module includes at least one of (i) an orbital position vector of the satellite module, and (ii) an orbital velocity vector of the satellite module. In some implementations, the operations include generating first control signals corresponding to the first control output and that are used to control an adjustment of the orbital state vector of the satellite module based on the magnetic field values and the location information. The operations can include deploying a solar sail of the satellite module based on the first control output and adjusting the orbital state vector of the satellite module using the solar sail, in response to deploying the solar sail. The operations can include configuring a vectoring component of the control system based on a timing parameter and a control instruction indicated by the first control output and performing the adjustment of the orbital state vector in response to configuring the vectoring component based on the timing parameter and the control instruction.

In some implementations, the operations include generating, by the control system, a first current signal that corresponds to an adjustment of the magnetic dipole force vector. The first current signal traverses a current loop path that is substantially parallel to a circumference of the satellite module. The vectoring component can include a reaction wheel and configuring the vectoring component can include configuring, using the first control output, one or more reaction wheels of the satellite module to spin at a speed corresponding to the adjustment of the magnetic dipole force vector. The operations can include generating, by the control system, a second current signal, and generating, using a magnetorquer and based on the second current signal, a counteracting magnetic dipole force vector. The operations can include the control system controlling an attitude of the satellite module by mitigating excess angular momentum of the satellite module based on the counteracting magnetic dipole force vector.

In some implementations, the first predictive model is a machine-learning (“ML”) inference model and the operations further includes processing, by the ML inference model, an input dataset including magnetic field values and location information about objects external to the satellite module. The operations include generating control outputs based on ML inferences computed as outputs of the ML inference model in response to processing the input dataset by the ML inference model. The operations include dynamically adjusting the orbital state vector of the satellite module based on the control outputs computed using the ML inference model.

In some implementations, the operations include computing, by a physics-based model of the control system, a second control output based on a deterministic control algorithm of the physics-based model that receives the magnetic field values or the location information as inputs to the deterministic control algorithm. In some implementations, the physics-based model is configured to: i) process, using the deterministic control algorithm, on-board sensor data generated at the satellite module and image-based location information about objects external to the satellite module, and ii) compute a plurality of control outputs for adjusting the orbital state vector of the satellite module based on attitude estimations determined from processing the on-board sensor data and image-based location information. The operations can further include detecting a difference between the first control output and the second control output in response to comparing the first and second control outputs. The operations can include identifying an inconsistency between respective orbital state vectors of the satellite module that correspond to the first and second control outputs based on the detected difference and adjusting the orbital state vector of the satellite module based on prioritization logic that resolves the inconsistency in favor of control outputs computed by a particular model of the satellite module.

In some implementations, the operations include receiving, from an external data source, data related to at least (i) the object external to the satellite module, or (ii) the satellite module. The operations include computing, by the first predictive model of the control system, the first control output based on the external data.

In some implementations, the satellite module is a first satellite module that communicates with a second satellite module, and the operations further include controlling the adjustment of the orbital state vector of the first satellite module by adjusting a magnetic dipole force vector of the first satellite module based on sensor data. The sensor data can be i) generated at the second satellite module, and ii) processed by the first satellite module after being received from the second satellite module. In some implementations, the first satellite module is part of a swarm including a plurality of other satellite modules and the operations further include receiving, by the first satellite module, sensor data generated by sensors integrated in at least one of the plurality of other satellite modules. The operations can include computing, by an ML inference model of the first satellite module, a swarm control output based on the sensor data. The swarm control output can include control settings that are used to adjust a respective orbital state vector of the other satellite modules in the swarm.

In some implementations, the satellite module is a planar, modular satellite configured for coupling to another planar, modular satellite. In some implementations, the first control output includes a predicted state vector for a particular time period for the satellite module based on data captured by the first sensor prior to the particular time period. In some implementations, the first control output includes a predicted state vector for a particular time period for the satellite module based on data captured by the second sensor prior to the particular time period. In some implementations, the first sensor includes one or more of a magnetometer, a magneto-resistive sensor, a vector sensor, and an inductive sensor. In some implementations, the second sensor includes one or more of a star-tracker sensor, a sun-tracker sensor, imaging sensor, camera, and a Global Positioning System (GPS) sensor.

In some implementations, the operations further include: generating thrust by a directional thruster of the satellite module based on the first control output, and controlling the orbital state vector of the satellite module based on the thrust generated by the directional thruster. In some implementations, the satellite module is part of a swarm including a plurality of satellite modules. The operations can further include controlling a respective orbital state vector of each satellite module in the swarm, configuring a swarm formation orbit by adjusting a respective magnetic dipole force vector of at least one satellite module of the swarm, and adjusting a configuration of the swarm formation orbit based on changes in magnetic field density of a celestial body orbited by the plurality of satellite modules of the swarm.

In some implementations, the operations further include generating, by the first sensor, second magnetic field values of a plurality of objects external to the satellite module. The operations can include computing, by the first predictive model of the control system, a control output based on the second magnetic field values and the location information. The operations can include controlling the orbital state vector of the satellite module by adjusting a magnetic dipole force vector of the satellite module based on the control output. In some implementations, adjusting the magnetic dipole force vector of the satellite module based on the first control output includes adjusting operation of an actively-generated magnetic field of the satellite module.

One aspect of the subject matter described in this specification can be embodied in a method using a control system of a satellite module. The method includes generating, by a first sensor, magnetic field values of an object external to the satellite module. The method includes generating, by a second sensor, location information of the satellite relative to the object external to the satellite module. The method includes computing, by a first predictive model of the control system, a first control output based on the magnetic field values and the location information. The method includes controlling an orbital state vector of the satellite module by adjusting a magnetic dipole force vector of the satellite module based on the first control output.

Other implementations of this and other aspects include corresponding systems, apparatus, and computer programs, configured to perform the actions of the methods, encoded on computer storage devices. A system of one or more computers can be so configured by virtue of software, firmware, hardware, or a combination of them installed on the system that in operation causes the system to perform the actions. One or more computer programs can be so configured by virtue of having instructions that, when executed by a data processing apparatus, cause the apparatus to perform the actions.

The subject matter described in this specification can be implemented in particular embodiments to realize one or more of the following advantages.

Increasing demands for AI computing will ultimately reduce available physical space and power allocations that are needed to execute ML workloads/tasks on terrestrial-based computing assets. These terrestrial assets for AI/ML computations are often represented by cloud infrastructures, including data centers, server farms, distributed computing platforms, as well as related ancillary assets, such as electric grids and microgrids. Each of these assets can have a sizable footprint with regard to electrical power demands and physical space.

To address these challenges with available power and space, this specification describes a control system and method to configure an AI satellite module to orbit a celestial body or system of bodies, such as the Earth or an Earth-Sun Lagrange Point. The satellite module can be configured to maintain a target orientation, e.g., a sun-facing orientation, to collect and convert solar power as a power supply for space-based execution of AI/ML computations. In contrast to the physical space available on Earth, the satellite module leverages the vast amount of space that is available when the satellite module orbits the celestial body, or system of bodies.

The disclosed technology leverages predictive and sensor-based techniques to improve orbiting and maneuvering for the satellite. By training and using a predictive model, the satellite can perform maneuvers, adjust orbits, perform attitude control and other types of satellite control using a sensor-based modeling approach that generates control outputs for controlling the satellite faster than physics-based models. In particular, physics-based models may demand numerous iterations and simulations that can be computationally expensive, whereas predictive techniques can be trained on historical sensor data and provide control outputs more efficiently. A trained predictive model can provide outputs faster than a physics-based model as the trained predictive model is trained and incentivized to identify an optimal control output in a relatively short period of time, which is well-suited for satellite maneuvers and applications such as collision avoidance.

In particular, the disclosed control system using predictive techniques learns from real-time sensor data captured by sensors of the satellite, and thus provides more adaptability than physics-based models, which rely on fixed-types of inputs and rigid assumptions that do not account for the dynamic nature of space. The trained predictive model can also be less sensitive to noise in the sensor measurements, as the model can be trained to account for noise and reduce the effect of noise to generate a control output over time. The predictive model can also be trained to identify energy efficient maneuvers and orbits, target orbits for optimal collection and conversion of solar power into electric power, among other missions performed by the satellite.

As another example, the model can be trained to identify and perform complex maneuvers that would otherwise demand a combination of different physics-based models. In contrast to combining multiple physics-based models for a control output, a single trained model can provide control outputs with lower computational complexity and computational resource consumption. The predictive model can also be trained to account for different types of missions performed by the satellite, such as by generating a control output that achieves a reduced likelihood of colliding with another object in space, increased likelihood of collecting solar power, as well as other mission types for the satellite.

The satellite can perform energy-intensive computing (e.g., 1,000 W per computing element) using a smaller physical footprint than terrestrial-based training assets. The disclosed control system allows for the satellite to efficiently rely on solar energy as a renewable energy source, thereby providing AI computing with little to no carbon emissions. The disclosed technology can prevent collisions between the satellite and other objects external to the satellite in the extraterrestrial environment, preventing damage to components such as the solar cells and/or the ML hardware accelerators and increasing the operational time for the satellite.

The details of one or more implementations of the subject matter described in this specification are set forth in the accompanying drawings and the description below. Other potential features, aspects, and advantages of the subject matter will become apparent from the description, the drawings, and the claims.

### BRIEF DESCRIPTION OF THE DRAWINGS

FIG. 1A is a diagram of an example artificial intelligence (AI) satellite module.

FIG. 1B shows an exploded view of the AI satellite module of FIG. 1A.

FIG. 1C is a diagram depicting example reference frames for the AI satellite module of FIG. 1A.

FIG. 1D is a diagram depicting an example control of the AI satellite module of FIG. 1A.

FIG. 1E is a diagram of another example AI satellite module.

FIG. 1F is another diagram of the example AI satellite module of FIG. 1E.

FIG. 1G is a diagram of another example AI satellite module.

FIG. 2A is a block diagram of a control system for individual control of the AI satellite module.

FIG. 2B is a block diagram of a control system for swarm control of multiple AI satellite modules.

FIG. 3A shows an example process for individual control of an AI satellite module.

FIG. 3B shows an example process for swarm control of multiple AI satellite modules.

Like reference numbers and designations in the various drawings indicate like elements.

### DETAILED DESCRIPTION

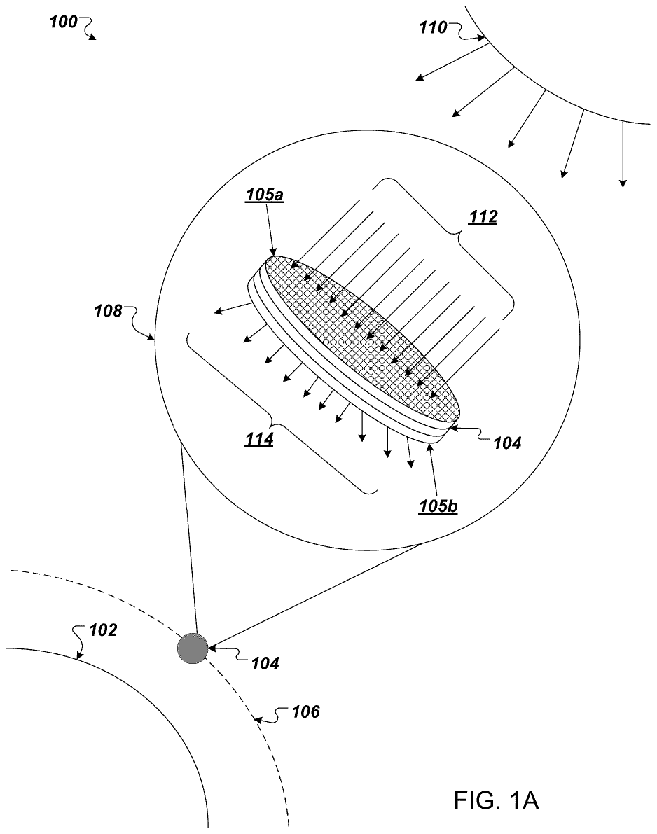

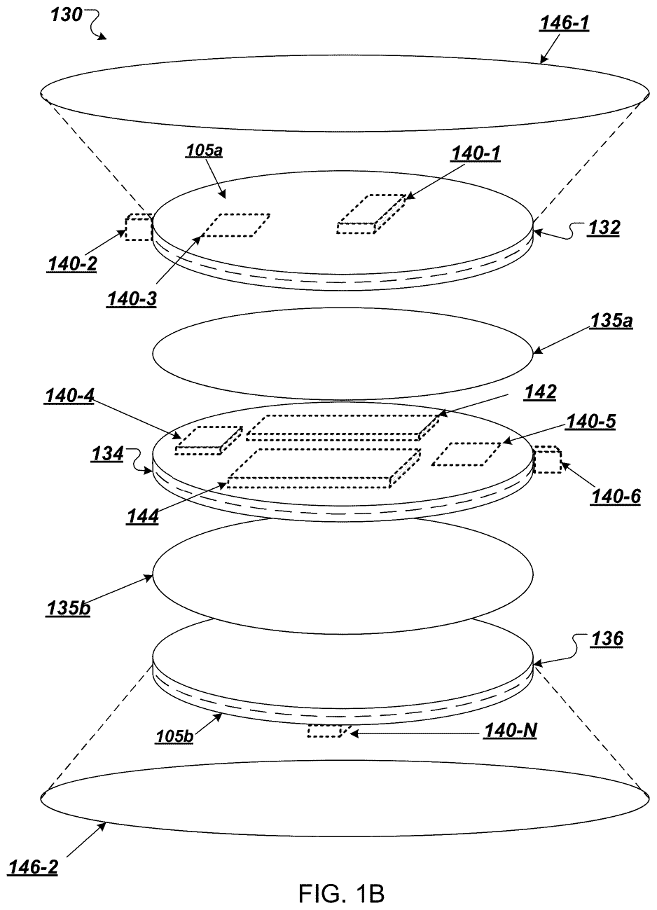

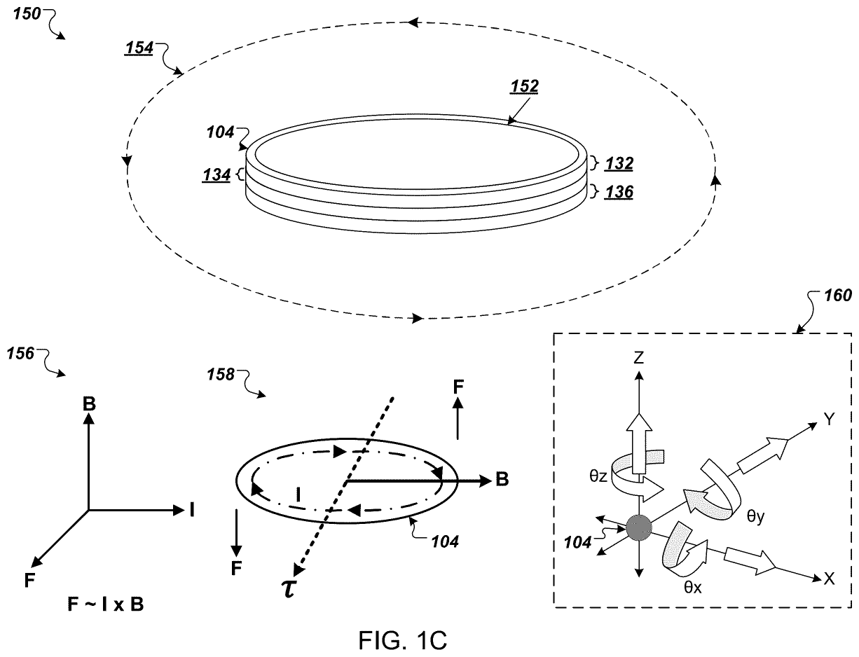

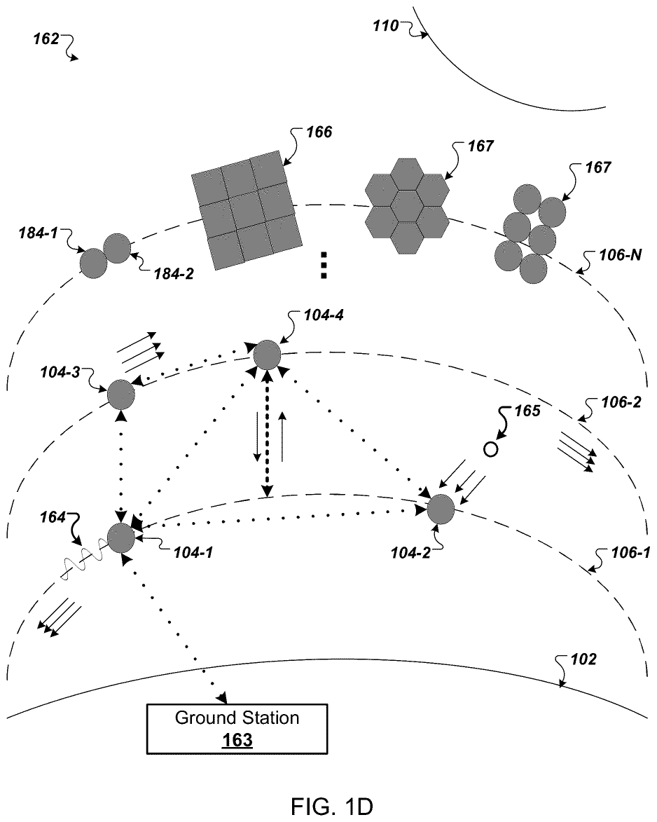

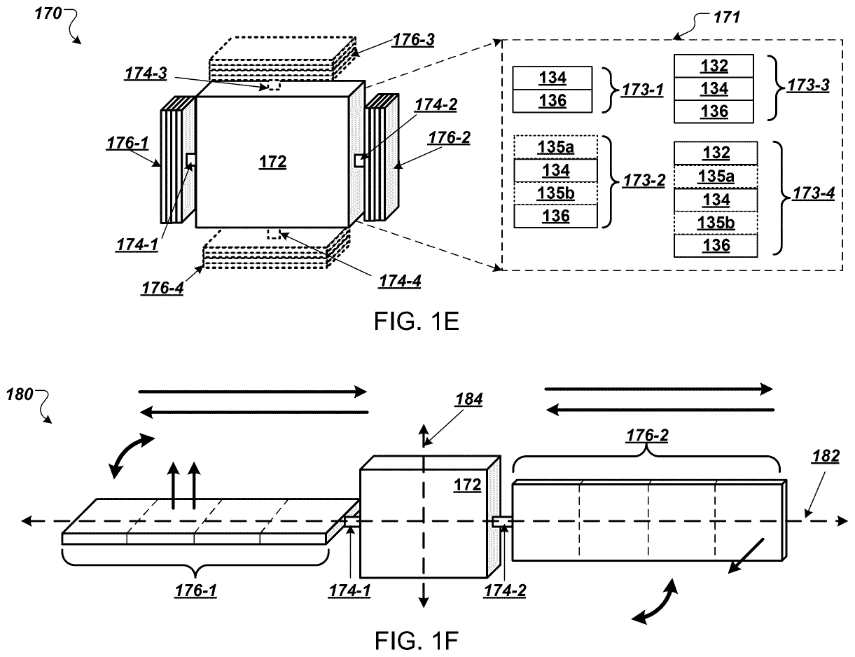

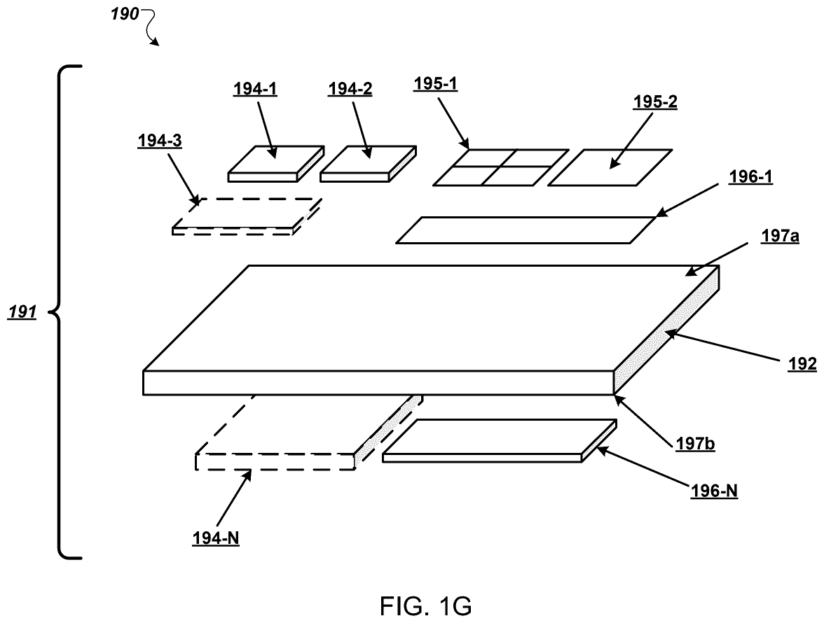

FIG. 1A is a diagram of an example extraterrestrial environment 100 (referred to herein as “environment 100”) for an artificial intelligence (AI) satellite module 104. The AI satellite module 104 can also be referred to as a “planar satellite 104,” where a shape, structure, or physical design of the satellite module 104 can be planar or substantially planar. For example, the AI satellite module 104 can have a planar shape that is relatively flat and thin. The AI satellite module 104 is referred to alternatively as “satellite 104.” Although FIG. 1A depicts the satellite 104 with a circular shape, the satellite 104 can have any outline or shape, e.g., hexagonal, square, and a relatively small size. For example, the satellite 104 can have a diameter of approximately 2 meters (e.g., for a circular shape), a size of approximately 2 meters by 2 meters (e.g., for a square shape), or a size of approximately 6 square meters for a hexagonal shape.

The environment 100 illustrates the satellite 104 maneuvering around a celestial body 102, e.g., a planet, moon, asteroid, or other type of object in space, along an orbital path 106. In the example of FIG. 1A the orbital path 106 is depicted as a curved dashed line that indicates an altitude of the satellite module 104 relative to the celestial body's surface. An example celestial body 102 can include the Earth. Although FIG. 1A depicts celestial body 102 as a single celestial body, the celestial body 102 can be a system of celestial bodies. For example, the system of celestial bodies can include a planet and its moons, satellites in the planet's orbit, etc. The satellite 104 can maintain any orbit 106 around the celestial body 102, such as a geosynchronous orbit, low-earth orbit (LEO), sun-synchronous orbit, decaying orbit, earth-trailing orbit, graveyard orbit, parking orbit, among other types of satellite orbits. In some implementations, the celestial body can be an object such as another spacecraft or satellite module in the extraterrestrial environment.

The environment 100 also includes a source 110 that emits or radiates light waves transporting light energy throughout the environment 100. For example, the source 110 can be a sun that radiates solar energy in the form of electromagnetic radiation that spans a broad spectrum of wavelengths. FIG. 1A illustrates a callout 108 that shows a zoomed-in view of the satellite 104 to depict the orientation of the satellite 104, e.g., relative to the celestial body 102 and the source 110. The callout 108 shows the satellite 104 having a first side 105a and a second side 105b opposite of the first side 105a. In the example of FIG. 1A, the first side 105a faces the source 110, whereas the second side 105b faces the celestial body 102.

The first side 105a can be referred to as a “top surface 105a,” and the second side 105b can be referred to as a “bottom surface 105b.” The top surface 105a can be part of a solar panel layer (“solar panel”) of the satellite 104 that allows for the collection of light energy and the conversion of light energy into electrical power. The satellite 104 includes a layer of machine-learning (“ML”) hardware accelerators adjacent to the solar panel layer. For example, this ML hardware layer can be below the top surface 105a and can utilize power generated by the top surface 105a, e.g., the solar panel layer, to perform inference and/or training ML workloads using the inference accelerators of the ML hardware layer.

The source 110 emits light energy in the form of electromagnetic radiation, which is represented by solar rays 112 that are received by the top surface 105a of satellite 104 at an incident angle. Although FIG. 1A depicts the rays 112 arriving at the satellite 104 at a substantially perpendicular incident angle relative to the top surface 105a, the satellite 104 can also receive rays at any incident angle that permits light energy to be received by a side of the solar panel layer that coincides with the top surface 105a of the satellite 104.

Referring to the bottom surface 105b of the satellite 104, the bottom surface 105b can be part of a heat dissipation layer that is adjacent to the ML hardware layer of the satellite 104. The heat dissipation layer radiates away heat from the satellite 104, such as heat from excess energy received from the top surface 105a and heat generated from the ML hardware layer when the inference accelerators are powered on to execute computations for ML tasks. The heat dissipation layer is configured to regulate the temperature of the satellite 104, such as by maintaining a target temperature or range of temperatures for the ML hardware. In some implementations, the ML hardware layer of satellite 104 is interposed between the solar panel layer and the heat dissipation layer. These and other layers of the satellite 104 are described in more detail below with reference to FIG. 1B, and 2A through 2E.

The heat dissipation layer is configured to remove or reduce heat energy generated from components and/or circuitry in the satellite module 104. For example, the heat dissipation layer is configured to remove or reduce the heat by way of heat transfer through dissipation, distribution, radiation, or combinations thereof. The heat dissipation layer, for example, can transfer away (e.g., by dissipating, distributing, radiating) heat generated by components of the satellite 104, such as the ML accelerators, solar panel layer, power delivery network, or integrated circuits of the satellite 104.

The satellite 104 can also be configured to convert other types of electromagnetic energy into electric power for computing tasks, e.g., training tasks, inference tasks. For example, the top surface 105a of the satellite 104 can be part of a layer of devices configured to convert forms of electromagnetic radiation (e.g., infrared, radio waves, gamma waves, ultraviolet). Examples of devices that use light waves to generate electric power for the satellite 104 can include thermophotovoltaic cells, UV photovoltaic cells, and other types of solar cells.

The callout 108 of FIG. 1A depicts heat waves 114 radiating from the bottom surface 105b of the satellite 104. The heat dissipation layer of the bottom surface 105b can be configured to radiate heat in a direction away from the satellite 104, e.g., to radiate an amount of heat. The satellite 104 can be configured to radiate away heat represented by heat waves 114 to achieve a target temperature or range of temperatures for the satellite 104. For example, the satellite 104 can prevent overheating of ML hardware and other components by radiating an amount of heat that maintains the temperature of components below a threshold temperature.

The threshold temperature can be an operating temperature that, if exceeded, reduces efficiency and/or prevents (or degrades) operability of the components in the environment 100. The satellite 104 can be configured to radiate away heat to maintain a temperature of a satellite 104 at, above, or below a particular threshold value that allows for improving operability and/or efficiency of certain components. For example, abnormally low operating temperatures for components in the ML layer (or other layers) can degrade performance or operability of the satellite 104, such as delaying circuit response times, reduce structural integrity, and decrease performance for semiconductor material.

The satellite 104 can also be configured to distribute and radiate away heat represented by heat waves 114 to reduce impact on orientation and position of the satellite 104. For example, the satellite 104 can determine a target value or range of values for orientation, position, etc., and radiate an amount of heat to reduce thermal recoil effect, which includes forces resulting from radiating heat that can affect the position or orientation of a satellite module 104.

Although FIG. 1A depicts the satellite 104 collecting light energy represented by solar rays 112 emitted by source 110, the satellite 104 can be configured to collect light energy from other sources. For example, the satellite 104 can be configured to collect light energy based on light waves that are refracted or reflected from other objects or sources other than source 110, e.g., celestial body 102. In contrast to the top surface 105a facing the source 110, the satellite 104 can adjust its orientation so that top surface 105a is facing the celestial body 102, which allows the solar panel layer to receive any light waves that are reflected or refracted from the celestial body 102. In this way, the satellite 104 can be configured to maintain an orbit that increases energy collection by collecting light energy from other sources or objects.

As described in reference to FIGS. 1B, 1C, and 1D below, a control system of the satellite 104 can adjust operation of a control adjustment system to achieve a target state, such as position, velocity, acceleration, and angles to achieve one or both of a position and an orientation for improved energy collection. Examples of angles can include orbital angles, attitude angles, and ground-based tracking angles. Examples of orbital angles for the satellite 104 can include inclination, right ascension of the ascending node, argument of perigee, true anomaly, mean anomaly, and eccentric anomaly. Examples of attitude angles for the satellite 104 can include roll, pitch, yaw. Examples of ground-based tracking angles for the satellite 104 can include azimuth, elevation, sub-satellite points (e.g., latitude and longitudinal coordinates on a surface of the celestial object below the satellite). As described in reference to FIG. 1D below, ground-based tracking angles of the satellite 104 can be transmitted from a ground-based tracking system such as a ground station to the satellite 104.

FIG. 1B shows an exploded view 130 of the AI satellite 104 of FIG. 1A. The exploded view 130 shows an example arrangement of the different layers and components of the satellite 104. The view 130 shows the satellite 104 having a solar panel layer 132 coupled to an ML hardware layer 134, which is further coupled to a heat dissipation layer 136. The exploded view 130 also shows an example solar sail 146-1 disposed above, or opposite a particular surface of, the solar panel layer 132 and a solar sail 146-2 disposed below, or opposite a particular surface of, the heat dissipation layer 136. The satellite 104 can optionally include one or both of the solar sails 146-1 and 146-2, each of which can be sheets of reflective material. The satellite 104 can also include additional solar sails based on design preference. The satellite 104 can deploy either or both of the solar sails 146-1 and 146-2 to provide propulsion for maneuvering the satellite 104 by reflecting photons from sunlight and using the radiation pressure (or light pressure) to provide a resulting thrust to the satellite 104.

For example, each solar sail 146-1, 146-2 can include one or more reflective panels that are configured to receive and interact with photons of light from source 110. The photons interact with the reflective panels in a manner that allows for using (or converting) the photons'momentum to propel the satellite module 104. In some implementations, each of the reflective panels includes a mirror-like surface that allows for reflecting the photons, which facilitates a transfer of momentum from the photons to the satellite module 104 when the photons interact with the reflective or mirrored surface of the panels. The satellite module 104 can adjust an angle, tilt, or other position of the reflective panels of its solar sails to control an orbital trajectory or direction of travel of the satellite module 104. For example, each solar sail 146-1, 146-2, including the reflective panels, can be in signal communication (e.g., wired or wireless) with a control module of the satellite module 104. The satellite 104 can adjust the reflective panels via control signals transmitted to, and received by, the solar sail, reflective panels, or both.

The exploded view 130 also shows an additional layer 135a interposed between the solar panel layer 132 and the ML hardware layer 134. The additional layer 135a can be a thin film made of a substrate that includes one or both of metal and composite. The additional layer 135a can provide structural support and/or thickness between the solar panel layer 132 and the ML hardware layer 134, providing additional mechanical strength and durability for the satellite 104, reducing or dampening vibrations from the environment 100, and improving thermal spreading between the solar panel layer 132 and the ML hardware layer 134. The exploded view 130 also shows an additional layer 135b interposed between the ML hardware layer 134 and the heat dissipation layer 136. The additional layer 135b can also be a layer of substrate similar to the additional layer 135a, but to provide thermal spreading, structural support/thickness, and vibration dampening for the ML hardware layer 134.

The exploded view 130 shows the satellite 104 having sensors 140-1 through 140-N (collectively “sensors 140”). The sensors can be located at different positions of the satellite 104. For instance, the view 130 illustrates a sensor 140-1 mounted on the top surface 105a of the satellite, which can be a top surface of the solar panel layer 132. The view 130 also shows a sensor 140-2 located on the periphery of the solar panel layer 132 and a sensor 140-3 contained in the solar panel layer 132. Sensors for the solar panel layer 132 can include irradiance sensors to measure intensity of the sunlight collected by the solar panel layer 132, temperature sensors to measure temperature of solar cells in the solar panel layer 132, among other types of sensors. The view 130 also shows a sensor 140-4 mounted onto the ML hardware layer 134, a sensor 140-5 contained in the ML hardware layer 134, and a sensor 140-6 protruding outward from the periphery of the ML hardware layer 134. The view 130 also shows a sensor 140-N mounted on the bottom surface 105b of the satellite 104, which can be a bottom surface of the heat dissipation layer 136.

Examples of a sensor from the sensors 140 can include sun sensors to detect a position of the Sun, Earth horizon sensors to detect the Earth's horizon line, apogee of the satellite, and perigee of the satellite. Examples of sensors 140 can also include star trackers to identify stars for attitude control, gyroscopes to measure angular velocity, and magnetometers to collect magnetic field measurements from the environment 100, including Earth's magnetic field. The satellite 104 can also include thermal sensors to measure temperature of the satellite 104, radiation sensors to measure radiation levels, altimeters to determine altitude for the satellite 104, and imaging sensors to track other objects such as satellites, orbital debris, etc. For instance, the imaging sensors can be configured to capture images of the environment 100 and any objects external to the satellite 104 in the environment, including objects within orbit of the celestial object and/or the satellite 104. The satellite 104 can also include spectrometers to collect data related to electromagnetic radiation, such as intensity, wavelength, and an amount of light that is absorbed, reflected, or transmitted.

The exploded view 130 also shows a control system 142 and a control adjustment system 144 as part of the ML hardware layer 134. The control system 142 and the control adjustment system 144 can be coupled to each other by signal communication channels, which can include any communication hardware, such as wires, cables, and other types of electronic communication mediums.

The control system 142 can process data collected and/or received by the satellite 104 to generate a control output for the control adjustment system 144. For example, the control system 142 can receive and process sensor measurements collected by sensors 140 of the satellite 104. As described in reference to sensors 140, the sensor measurements can include magnetic field measurements from objects external to the satellite 104. The sensor measurements can also include location information, such as position, orientation, and other types of object state information, of one or more objects external to the satellite 104. The control system 142 can determine, such as by computing and/or predicting, an adjustment of a state vector for the satellite 104 to control the attitude, position, orbit, or another type of state for the satellite 104. The control system 142 provides the control output to the control adjustment system 144 to generate control signals to perform the adjustment of the state vector. The adjustment of the state vector can be performed by adjusting a magnetic force vector of the satellite 104 using the control output based on the magnetic field values and the location information.

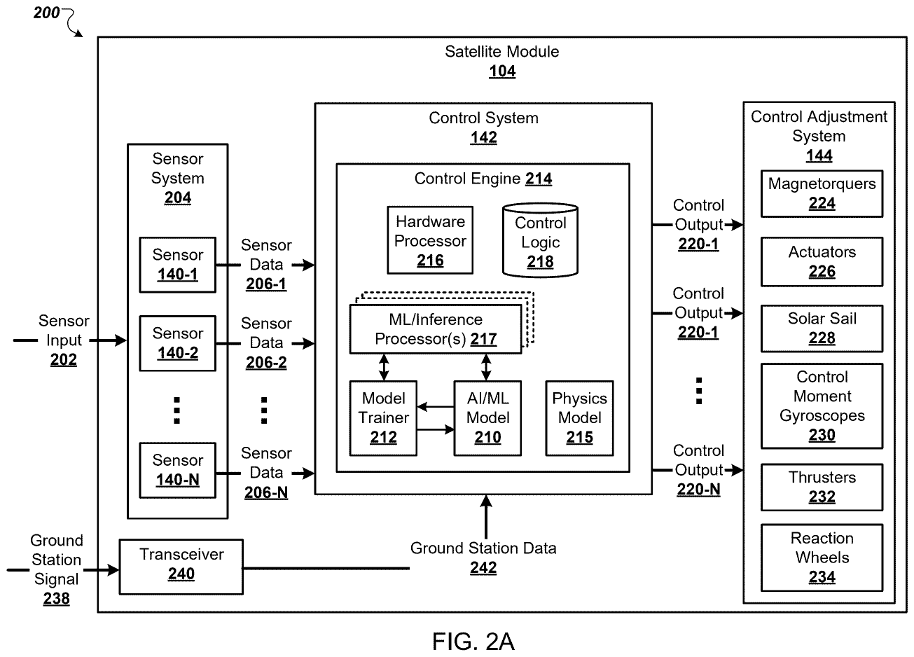

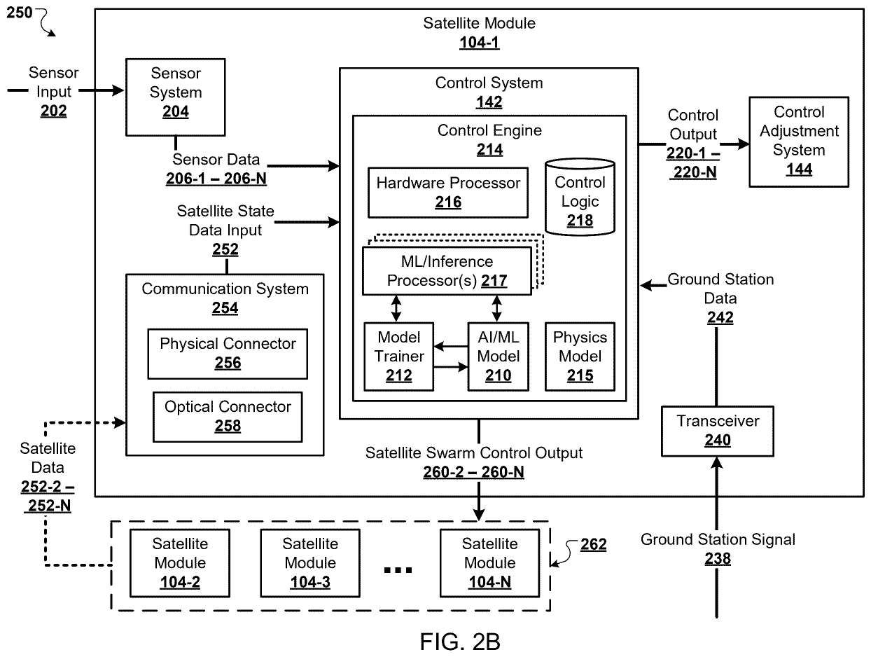

In some implementations, the control system 142 processes data transmitted by an external source to the satellite 104 to compute the control output. Examples of external sources can include one or more satellites different from the satellite 104, as well as a ground station located at a terrestrial surface of a celestial body. The control system 142 can include a control engine, hardware processor, memory for control logic, physics-based models, AI/ML models, and a model trainer for the AI/ML models, as described in reference to FIG. 2A below.

The control adjustment system 144 can receive the control output generated by the control system 142 and apply the control output to maneuver the satellite 104. For example, the control adjustment system 144 can generate control signals for vectoring components that can implement the adjustment of the state vector for the satellite 104. Examples of the vectoring components of the control adjustment system 144 can include magnetorquers, actuators, solar sail deployment mechanisms for the solar sail 146-1 and 146-2, control moment gyroscopes, thrusters, reaction wheels, and other types of mechanisms, as described in reference to FIG. 2A below. As an example, the control adjustment system 144 can deploy a solar sail based on control signals and adjust the orbital state vector of the satellite 104 by deploying the solar sail.

The control adjustment system 144 can apply the adjustment to the state vector by performing an adjustment of the magnetic force vector of the satellite 104. For example, the control adjustment system 144 can perform the adjustment in the state vector by generating a current having a particular value that corresponds to an adjustment of the magnetic force vector. The control adjustment system 144 can also adjust the operation of vectoring components such as reaction wheels to operate in a way that achieves the magnetic force vector adjustment. For example, the control adjustment system 144 can cause or configure one or more reaction wheels to spin at a speed corresponding to a target magnetic dipole force vector, e.g., to achieve a particular amount and direction for the magnetic dipole force vector. Further description of adjusting the magnetic force vector is described in reference to FIGS. 1C, 2A, and 2B below.

Although the view 130 shows the control system 142 and the control adjustment system 144 mounted on the ML hardware layer 134, either or both of the systems can be embedded in the ML hardware layer 134. In some cases, the control system 142 can be located on or mounted in a first surface, while the control adjustment system 144 is located on or mounted in a second surface different from the first surface. In some cases, the control system 142 and the control adjustment system 144 can be arranged at different layers relative to each other.

FIG. 1C is a diagram showing an example reference frame 150 for the AI satellite module of FIG. 1A. The reference frame 150 shows an example rotational acceleration 154 that can be achieved by the satellite 104 by running a loop of current along a substantially circular path 152. For example, the current can be generated and run along a circumferential path relative to the periphery of the satellite 152. The control adjustment system 144 can generate a current at perpendicular angles relative to a magnetic field of an object external to the satellite 104, such as an external magnetic field. In this way, the resulting forces generated by the current loop can accumulate to generate a torque around the center of mass for the satellite 104. Examples of the external magnetic field can include the magnetic field of a celestial body and/or other satellites in the environment 100.

FIG. 1C also includes example coordinate frames 156, 158, and 160 to illustrate the application of Lorentz's equation to generate adjustments for maneuvering the satellite 104. For example, the coordinate frame 156 shows a coordinate frame indicating that the force F generated by a current is proportional to a cross product between the current I and the external magnetic field B. In particular, the expression of shown in F~I×B for the coordinate frame 156 indicates a force on a current carrying conductor (e.g., the satellite 104) in a magnetic field B. In other words, the Lorentz force F is a cross product (e.g., by applying the right hand rule) to indicate the direction of the generated force vector F, based on relative directions between the current vector I from the satellite 104 and the magnetic field vector B from an external magnetic field.

The coordinate frame 158 illustrates an example to show that the magnetic force vector F resulting (illustrated as an upward arrow) from the generated current I running clockwise and interacting with the external magnetic field B. The magnetic force vector F is a result from the torque τ generated by the control adjustment system 144 running the current I in a loop. The amount of generated torque τ can correspond to the target control output determined by the control system 142. A force F directed downward from the satellite 104 can also be generated by running the current in an opposite direction, e.g., counterclockwise.

The coordinate frame 160 illustrates a three-dimensional (3D) coordinate frame with three axes (x-axis, y-axis, and z-axis) with the satellite 104 depicted as a solid-fill gray circle. The satellite 104, through the control adjustment system 144, can generate adjustments along one or more of the x-direction, y-direction, and the z-direction. The control adjustment system 144 can also generate adjustments resulting in rotations about an axis. For example, the control adjustment system 144 can generate adjustments in pitch, roll, and yaw, depicted in the coordinate frame 160 as θx, θy, and θz, respectively.

FIG. 1D is a diagram 162 depicting an example control of the AI satellite 104 of FIG. 1A. The diagram 162 shows different orbits 106-1 through 106-N of satellites relative to the celestial object 102. For example, the diagram 162 shows satellites 104-1 and 104-2 maintaining an orbit 106-1 around celestial body 102. The diagram 162 shows satellites 104-3 and 104-4 maintaining an orbit 106-2, which is a further distance away from the celestial body 102 than the orbit 106-1, e.g., a satellite on orbit 106-2 has a greater orbital altitude than a satellite on orbit 106-N. The diagram 162 also depicts examples of satellite clusters using multiple satellites on an orbit 106-N, in which satellites on orbit 106-N have a greater orbital altitude than orbits 106-1 and 106-2. Similar to satellite 104 in FIG. 1C, the satellites in FIG. 1D are depicted with gray, solid fill circles. Satellites may travel in a counterclockwise orbit (such as to follow a rotation of a celestial body 102 like Earth), such as orbit 106-1.

In some implementations, the satellite can travel in a clockwise orbit, such as orbit 106-2 depicted in FIG. 1D. In some implementations, the satellite can perform maneuvers to change direction of orbit or change a type of orbit, such as from a geosynchronous orbit to a polar orbit or a low-earth orbit. For example, FIG. 1D depicts an example of satellite 104-4 transitioning from an orbit 106-2 to an orbit 106-1 with a dashed-double arrow line. Although not illustrated in FIG. 1D, a satellite can also adjust orbital altitude to transition from a lower orbital altitude to a higher altitude. Furthermore, although the transition between orbit 106-2 to orbit 106-1 for satellite 104-4 is depicted as a substantially vertical direction, the transition between orbits can be any trajectory, e.g., a curved trajectory that gradually increases or decreases the orbital altitude over a period of time.

Referring to orbit 106-1, satellite 104-1 is depicted with dotted, double-arrow lines to indicate free-space communication (e.g., optical, radio) with other satellites. Satellite 104-1 can be configured to communicate with satellites 104-2 in the same orbit 106-1 as satellite 104-1, but can also communicate with satellites in other orbits, such as satellite 104-3 and 104-4 in orbit 106-2. As another example, satellite 104-4 can be configured to communicate with satellite 104-3, 104-2, and 104-1. The satellites 104-1, 104-2, 104-3, and 104-4 can be referred to as a “swarm” of satellites. As described in reference to FIG. 2B below, a control system 142 of a satellite 104 can be configured to generate control outputs for itself or other satellites, based on orbital state vectors of other satellites in the swarm. Furthermore, a control system of a satellite 104 can also be configured to generate a control output based on data collected by an external source for the satellite, such as sensor data collected from sensors and/or data from external sources such as a ground station. Satellites can include a transceiver, optical communication system, physical connector, or some combination thereof, to transmit data between satellites in the swarm.

As an example, as satellite 104-1 can include a transceiver to communicate with a terrestrial ground station 163 of the celestial body 102. The satellite can transmit and receive data from ground station 163, including data for processing by the ML hardware layer 134 to perform machine learning tasks. The satellite can also receive observation data collected by the ground station 163 to adjust the orbit of the satellite, transition between orbits, and/or perform a maneuver.

Each of the control systems for each of the satellites can be configured to communicate state information about the respective satellite to other satellites. Communication between satellites can allow for distribution of computing power across multiple satellites. For example, free-space communication between satellites can allow for data transfer between two or more satellites, such as to distribute computational loads associated with machine learning tasks among multiple satellites rather than a single satellite performing the tasks.

The satellites 104 depicted in FIG. 1D each include a respective control system 142 and control adjustment system 144, as described in reference to FIG. 1B. The control system 142 and the control adjustment system 144 can configure its respective satellite to achieve a target orbit, transition between two orbits, and/or perform a maneuver. Examples of maneuvers can include collision avoidance with other objects in the environment, maintaining a target orientation for improved collection of solar energy from source 110, achieving particular positions and/or orientations relative to other satellites to form constellations, maintaining a threshold distance from another satellite to permit efficient communication via free-space optical communication, and maintaining a threshold distance to permit physical connection between two or more satellites.

As an example of collision avoidance, the satellite 104-2 along orbit 106-1 is depicted in FIG. 1C as having a trajectory that can potentially intersect with a trajectory of another object in the extraterrestrial environment, e.g., object 165 depicted as a white, solid-filled circle. The satellite 104-2 can detect the presence of the object 165 based on sensor measurements collected by sensors 140. In response to detecting a potential collision with another object, the satellite 104-2 can perform a maneuver to reduce the likelihood of collision, such as by moving faster or slower along the orbit 106-2 and/or by transitioning to another orbit. The satellite 104-2 can utilize absolute and/or relative state information for the satellite (e.g., position, velocity, acceleration) and determine a control output using the control system 142 to perform a maneuver.

In some implementations, the satellite 104-2 can detect an instance of an object based on electromagnetic sensor measurements. In some cases, the type of object can be classified based on the sensor measurements, as some object types can demonstrate a particular pattern or reflectivity. For example, the pattern of electromagnetic radiation reflected from some types of debris can demonstrate more scattering compared to the pattern of radiation reflected from a solid-body object, such as another satellite. The satellite 104-2 can also receive sensor measurements, state information, and/or control outputs from other sources to perform collision avoidance. For example, the ground station 163 can transmit state information of objects on an intersecting trajectory with the satellite 104-2 on orbit 106-1.

In some implementations, a satellite 104-1 may experience an oscillation 164 along the orbit 106-1 due to perturbations in its orbit, such as uneven gravitational pull from celestial body 102. A satellite can be configured to perform a maneuver that mitigates the effect of the perturbations from an oscillation 164 on the orbit for a satellite.

Referring to the orbit 106-N, different clusters of satellites are depicted in FIG. 1D. For example, a pair of satellites 184-1 and 184-2 are shown in a configuration where both satellites maintain a physical connection when traveling along the orbit 106-N. In a cluster of satellites, a control system of one satellite can be configured to operate as a master control system for all satellites in the cluster. The role of the master control system can be transitioned from a control system of a first satellite to another control system of another, different satellite, based on available bandwidth, power, and any other related processing demands. Each of the satellites 184-1 and 184-2 can include a physical connector configured for mating to another physical connector of a satellite. In some cases, the physical connector can be electrical contacts formed by dynamic spot welding.

In some implementations, a first satellite such as satellites 184-1 may be launched into an orbit 106-N or transitioned from another orbit, e.g., orbit 106-2, to couple to a second satellite 184-2. In some implementations, the satellite 184-1 can be configured as a payload carrying data for transmission to the satellite 184-1, e.g., a batch data upload to an orbiting satellite 184-2. In some implementations, a satellite can be configured to mate with multiple other satellites to form a satellite cluster. The multiple satellites can be configured to collectively process the data, e.g., distributing processing operations across different satellites.

The example clusters may be preferred to allow for physical data transmission between two or more satellites, which can be a faster data transmission rate than free-space communication between the same satellites. As described in reference to FIG. 1A, a satellite can have any shape. For example, satellite cluster 166 is depicted as an array of nine satellites 104, each having a substantially square shape that permits physical connection with each other. The satellites in a cluster can also have other shapes, such as hexagons, circles, etc. In another example, the satellite cluster 167 depicts seven hexagonally-shaped satellites arranged in a formation that permits physical connection between adjacent satellites, along substantial parts of the perimeter. A satellite cluster 168 depicts six circular-shaped satellites that can be arranged to form a satellite cluster in which one satellite physically couples to another satellite at a relatively small portion of the adjacent satellite's perimeter, compared to shapes of satellites in the clusters 166 and 167.

In some implementations, satellite clusters 166 and 167 can be configured as a phased array antenna. For example, each satellite in a cluster can include an antenna for transmitting and receiving radio waves. The antennas for the satellites in the cluster can be arranged in a pattern, each antenna having a particular phase-adjusted signal. By forming a phased array antenna, the satellite cluster can provide improved data transmission to another satellite or a ground station 163, e.g., at longer distances and with lower signal loss, compared to a single satellite antenna transmitting data at the same distance as the satellite cluster.

A configuration of multiple satellites 104 into a cluster can provide increased coverage area of the solar panel layers to form a larger surface area for collecting solar energy. A cluster configuration for satellites can also provide improved computing task distribution due to the larger number of available machine learning hardware, with reduced data loss compared to free-space communication because the satellites in the cluster configuration are physically connected.

FIG. 1E is a diagram of another example AI satellite module 170, also referred to as “satellite 170.” The satellite 170 includes a central satellite bus 172 having an integrated design where the ML hardware layer 134 and the heat dissipation layer 136 are part of the same structure. In contrast to the example design depicted in FIGS. 1A through 1D, the example design depicted in FIG. 1E includes deployable solar panel layers, e.g., solar panel layer 132, as structures coupled to the central satellite bus 172, e.g., additional solar panel layers 132 being deployable and separate from the central satellite bus 172. The coupled solar panel layers for the satellite 170 are depicted as deployable satellite arrays 176-1 through 176-4 (collectively referred to as “deployable satellite arrays 176”) protruding outward from the central satellite bus 172. Each of the deployable satellite arrays 176 can be a solar panel layer 132, and thus each array includes solar cells for collecting solar energy and converting to electrical power. Each deployable satellite array can be coupled to the central satellite bus 172 by a respective deployment mechanism.

For example, a first deployable satellite array 176-1 can be connected to the central satellite bus 172 by a first deployment mechanism 174-1. A second deployable satellite array 176-2 can be connected to the central satellite bus 172 by a second deployment mechanism 174-2. The central satellite bus 172 can configure a deployment mechanism to control operation of the deployable satellite array using the deployment mechanism connected to the central satellite bus 172. Configuring a deployment mechanism can include applying control signals from the control system 142 to extend the deployable solar array, e.g., outward and away from the central satellite bus 172. In this way, the solar cells in the deployable solar array can be exposed to solar energy in the extraterrestrial environment 100, e.g., for collecting and converting said solar energy. Configuring the deployment mechanism can also include rotating the deployment mechanism to rotate an angle of orientation of the deployable solar array, as described in reference to FIG. 1E below.

The central satellite bus 172 includes an integrated body for the satellite 170 that includes the ML hardware layer 134, the heat dissipation layer 136, and can optionally include related propulsion and communication components. For example, callout 171 shows a first example 173-1 of the central satellite bus 172 including the ML hardware layer 134 and the heat dissipation layer 136, similar to the arrangement depicted in FIG. 1B, but does not show the solar panel layer 132. The callout 171 shows a second example 173-2 of the central satellite bus 172 including the ML hardware layer 134, the heat dissipation layer 136, and one or both of the additional layers 135a and 135b. This also is similar to the arrangement depicted in FIG. 1B, but absent the solar panel layer 132. The callout 171 shows a third example 173-1 of the central satellite bus 172 including the solar panel layer 132, the ML hardware layer 134 and the heat dissipation layer 136, similar to the arrangement depicted in FIG. 1B. The callout 171 shows a fourth example 173-4 of the central satellite bus 172 including the solar panel layer 132, the ML hardware layer 134, the heat dissipation layer 136, and one or both of the additional layers 135a and 135b. This also is similar to the arrangement depicted in FIG. 1B. The control system 142 can be part of the ML hardware layer and/or the additional layers 135a and 135b, as described in reference to FIG. 1B above.

The satellite 170 can include any number of deployable satellite arrays and a corresponding number of deployment mechanisms to configure said deployable satellite arrays. For example, the satellite 170 can optionally include a third deployable satellite array 176-3 connected to the central satellite bus 172 by a third deployment mechanism 174-3 and a fourth deployable satellite array 176-4 connected to the central satellite bus 172 by a fourth deployment mechanism 174-4.

FIG. 1F is another diagram of the example AI satellite module 170 of FIG. 1E. The diagram 180 shows the deployable solar arrays 176-1 and 176-2 fully extended outward from the central satellite bus 172. The diagram 180 also depicts an axis 182 to show the direction along which the solar arrays can be extended and retracted, relative to the central satellite bus 172. In instances where the central satellite bus 172 includes deployable satellite arrays and their associated deployment mechanisms on a different surface of the central satellite bus 172, e.g., deployable satellite arrays 176-3 and 176-4, the central satellite bus 172 can configure the deployment mechanisms to extend or retract along an axis 184, e.g., depicted as substantially perpendicular to axis 182. FIG. 1F also shows dashed lines for each of the deployable solar arrays 176-1 and 176-2 to indicate that the solar arrays are foldable. In this way, the satellite 170 can be launched into orbit and perform any maneuvers while the deployable solar arrays 176 are in a fully folded and retracted position.

The satellite 170 can deploy the deployable solar arrays 176 by extending and unfolding the solar arrays, e.g., upon achieving a target orbit, position, etc. The satellite 170 can include the control system 142, such as the system described in reference to FIGS. 1B, 2A, and 2B. The control system 142 can determine control adjustments, generate control signals corresponding to the adjustment, and apply the control signals to adjust operation of the deployment mechanisms 176. Adjustments can include folding or unfolding the deployable solar arrays 176 to retract or extend, respectively, the deployable solar arrays 176. Another adjustment of the deployable solar arrays 176 can include rotating the deployable solar array about an axis. For example, FIG. 1F depicts a rotation of deployable solar array 176-1 about the axis 182 to orient a top surface of the deployable solar array 176-1 in a target direction. Said target direction of a deployable solar array can be a different direction than another deployable solar array of the satellite 170, e.g., the deployable solar array 176-1 is oriented in an upward direction whereas the deployable solar array 176-2 is oriented in a direction substantially perpendicular to the upward direction.

FIG. 1G is a diagram of another example AI satellite module 191, also referred to as “satellite 191.” FIG. 1G depicts an exploded view 190 of satellite 191 assembled out of multiple compute dies bonded to a layered substrate that contains local communications, power distribution, heat distribution/dissipation, and solar layers. The satellite 191 includes a layered substrate 192 and a number of compute dies 194-1 through 194-N (collectively “compute dies 194”), which can each include a number of machine learning hardware accelerators. For example, the compute dies 194-1, 194-2, and 194-3 are bonded to a top surface 197a of the layered substrate 192 and a compute die 194-N is bonded to a bottom surface 197b of layered substrate 192, the bottom surface 197b opposite the top surface 197a. Although view 190 depicts the satellite 191 having four compute dies, any number of compute dies can be attached, e.g., by bonding, to the layered substrate 192.

The layered substrate 192 can be a semiconductor substrate formed by depositing multiple layers, e.g., thin layers of material, onto a base substrate. The layered substrate 192 can include semiconductor material, superconductor materials, insulators, conductors, or some combination thereof. The compute dies 194 can be bonded to, e.g., attached, to the layered substrate 192 using different bonding techniques, such as direct bonding, adhesive bonding, anodic bonding, eutectic bonding, among other types of bonding. The compute dies 194 can be part of the ML hardware layer 134, as described in reference to FIGS. 1A, 1B, and 1D above.

With respect to the top surface 197a, components of the satellite 191 other than then the illustrated compute dies 194-1, 194-2, and 194-3 can be part of and/or mounted to the top surface 197a of the layered substrate 192, e.g., in addition to or instead of the compute dies 194-1 through 194-3. For example, components of the solar panel layer 132 described in reference to FIGS. 1A, 1B, and 1D above, such as solar cells, panels, and other types of photovoltaic devices, can part of and/or mounted to the top surface 197a of the layered substrate 192. The exploded view 190 depicts an array of solar cells 195-1 and a solar panel 195-2 located at the top surface 197a of the layered substrate 192. In another example, components of the heat dissipation layer 136 can part of and/or mounted to the top surface 197a, such as heatsinks, heat pipes, and other types of heat dissipating/radiating structures. For example, a heatsink structure 196-1 of the heat dissipation layer 136 can be mounted to, or part of the top surface 197a of the satellite 191.

Similarly, components of one or more layers for the satellite 191, e.g., the solar panel layer 132, the ML hardware layer 134, and the heat dissipation layer 136, can be part of and/or mounted to the bottom surface 197b of the satellite 191. For example, the exploded view 190 depicts the compute dies 194-N and a heatsink structure 196-N as part of and/or mounted to the bottom surface 197b. Any number of components can be mounted to or part of the layered substrate 192.

Referring the layered substrate 192, any of the components, subsystems, and systems for control, communications, e.g., such as the subsystems described in reference to FIGS. 1B, 1D, 2A, 2B, can be part of the layered substrate 192. For instance, the layered substrate 192 can include a combination of solar cells, e.g., photoelectric devices from the solar panel layer 132, and heat dissipation elements, e.g., such as radiators, heat pipes, and other types of heat radiating components from the heat dissipation layer 136. In this way, the top surface 197a can have regions of solar cells, such as solar cells 195-1 and solar panel 195-2, intermixed with radiating surfaces, such as the heatsink structure 196-1, for heat dissipation. The compute dies 194-1-194-3 from the ML hardware layer can be intermixed at the top surface 197a with the components of the solar layer and the heat dissipation layer, as well as circuit components for power delivery, control, communications, etc. the compute dies can include radiation hardening, copper shielding, and/or other types of material to reduce the likelihood of radiation damage to the ML hardware accelerators and related circuitry. Intermixing heat distribution components and solar panel components can be desirable, as some angles, trajectories, orbits, etc. relative to a solar source can receive substantive amounts of solar exposure. By intermixing heat distribution components with solar panel components, the heat dissipation components, e.g., heatsink structure 196-1, of the satellite 191 can distribute excess heat for a solar-facing side of the satellite, e.g., the top surface 197a, while the solar panel components, e.g., solar cells 195-1 and solar panel 195-2, provide electrical power to components of the ML hardware layer, e.g., the compute dies 194-1-194-N.

Although FIG. 1G depicts the compute dies 194-1 through 194-3 bonded to a top surface 197a of the layered substrate 192, additional compute dies such as compute die 194-N can be bonded to a second side of the layered substrate 192 opposite the top surface 197a. For instance, FIG. 1G depicts the compute die 194-N bonded, e.g., attached, mounted, to the bottom surface 197b of the layered substrate 192, e.g., a side of the layered substrate opposite to where the compute dies 194-1 through 194-3 are bonded. Although FIG. 1G depicts intermixed components from solar panel layer 132 and the heat dissipation layer 136 at the top surface 197a for the satellite 191, components from the solar panel layer 132, ML hardware layer 134, and heat dissipation layer 136, or some combination thereof, can also be intermixed at the bottom surface 197b. For example, the bottom surface 197b of the layered substrate 197b can include a mix of components for communications, control, power distribution, heat distribution/dissipation, machine learning hardware computations, and solar energy conversion.

FIG. 2A is a block diagram 200 of a control system 142 for individual control of the AI satellite module 104 (“satellite 104”). The block diagram 200 shows the satellite 104 including the control system 142 coupled to a control adjustment system 144, as described above in reference to FIG. 1B. The satellite 104 also includes a sensor system 204 that includes the sensors 140-1 through 140-N, also described above in reference to FIG. 1B. Sensors in the sensor system 204 can capture sensor input 202 and each sensor can generate a respective set of sensor data 206 for the control system 142. The control system 142 can generate one or more control outputs 220-1 through 220-N (collectively “control outputs 220”) to be administered by the control adjustment system 144.

The control adjustment system 144 can include magnetorquers 224, actuators 226, one or more solar sails 228, control moment gyroscopes (CMGs) 230, one or more thrusters 232, and one or more reaction wheels 234 to implement the control output from the control system 142. Examples of thrusters can include ion thrusters, chemical thrusters, cold gas thrusters, among other types of thrusters for spacecraft orbit and maneuvers. The control system 142 determines one or more control outputs 220 based on the sensor input 202 that corresponds to an adjustment of a magnetic field vector, e.g., magnetorquers, reaction wheels, and/or ancillary maneuvering from other non-magnetic field related components, e.g., solar sails, thrusters, control moment gyroscopes, and actuators.

The control outputs 220 may also be referred to as “control signals 220.” In some instances, the control system 142 can generate a control output 220-1 for the control adjustment system 144 that is a high-level instruction indicating a target adjustment of a state vector for the satellite 104, e.g., adjust orientation of the satellite by a number of degrees in a particular direction. The control adjustment system 144 can be configured to generate and provide low-level instructions corresponding to the high-level instruction, in which the low-level instruction includes individual instructions for vectoring components of the control adjustment system 144 to administer the target adjustment of the state vector.

In other words, the control adjustment system 144 can be configured to translate high-level control from the control system to low-level control to vectoring components of the control adjustment system. In some implementations, the control output 220-1 is a control signal to provide individual control to one or more vectoring components of the control adjustment system 144, e.g., instructions capable of direct processing by the vectoring component. Although FIG. 2A depicts the control system 142 and the control adjustment system 144 as separate blocks, in some cases, the control system 142 and the control adjustment system 144 can be combined into a single control system and adjustment module for the satellite 104. Relatedly, although FIG. 2A depicts the sensor system 204 and the control adjustment system 144 as separate blocks, in some cases, one or more sensors of the sensor system 204 may be integrated in the control adjustment system 144 can be combined into a single control system and adjustment module for the satellite 104.

In some implementations, the control signals 220 can cause the control adjustment system 144 to generate a current signal having a particular value that corresponds to an adjustment of the magnetic dipole force vector. The current signal can be generated by the control system 142 and/or the control adjustment system 144. The current signal can correspond to an adjustment of the magnetic dipole force vector and can traverse a current loop path that is substantially parallel to a circumference of the satellite 104, such as the path depicted in FIG. 1C above. In some implementations, the control signals 220 can also include configuring the reaction wheels 234 to spin at a speed corresponding to the adjustment of the magnetic force vector.

In some cases, the control system 142 determines an excess angular momentum and generates a second current signal that results in a counteracting magnetic dipole force vector to mitigate the excess angular momentum. For example, the control system 142 can be configured to determine an excess amount of magnetic force in the magnetic force vector. The control system 142 can generate a counteracting magnetic force vector using the magnetorquers 224 based on the excess angular moment. For example, the control system 142 can generate a current signal that corresponds to a counteracting magnetic dipole force vector to be generated by the magnetorquer of the control system, e.g., by the magnetorquer providing an actuation motion to the satellite. The control system 142 can be configured to control an attitude of the satellite using the generated counteracting magnetic dipole force vector to “bleed” the excess angular momentum, e.g., mitigating the excess angular momentum over a time period.

In some implementations, the control outputs 220 indicate timing information for generating a magnetic force vector and for performing a control operation to control an orbital trajectory (or speed) of the satellite module based on the magnetic force vector. The magnetic force vector can correspond to a target angle, trajectory, or orientation of the satellite 104.

The control system 142 can generate control signals that include timing parameters and control instructions for configuring vectoring components for the satellite 104. For example, timing parameters can indicate a time instance for performing a control action using the vectoring component and the control instructions can indicate the low-level commands for input to the vectoring component to perform the control action. The control action can be an adjustment of the orbital state vector, e.g., in response to configuring the vectoring component based on the timing parameter and the control instruction.

Referring to the sensor system 204, each sensor can generate a set of sensor data based on sensor input 202 from an environment of the satellite 104. Generally, a sensor 140-1 of sensor system 204 can generate sensor data 206-1 and sensor 140-N of sensor system 204 can generate sensor data 206-N. In some cases, one sensor from sensor system 204 can generate sensor data from a first portion of the electromagnetic spectrum and another sensor from sensor system 204 can generate sensor data from a second portion of the electromagnetic spectrum, e.g., a different portion than the first portion or partially-overlapping with the first portion of the electromagnetic spectrum. In some implementations, two different sensors from sensor system 204 can generate sensor data based on different types, instances, or both types and instances, of sensor input 202. As an example, a first sensor 140-1 can generate sensor data 206-1 from sensor input 202 collected at a first time instance and a second sensor 140-2 can generate sensor data 206-2 from sensor input 202 collected at a second time instance after the first time instance.

Examples of sensor input 202 can include different types of electromagnetic radiation (e.g., infrared, ultraviolet, and x-ray), thermal radiation, radio waves, microwaves, sunlight, charged particles, solar wind (and related plasma), ionospheric conditions, cosmic rays and other types of solar radiation, light from celestial objects, among other conditions of the extraterrestrial environment.

A sensor from the sensor system 204 can be a different type of sensor compared to types of other sensors in the sensor system 204. For example, the sensor system 204 includes a first sensor, e.g., sensor 140-1, configured to process a sensor input of magnetic field measurements and generate a corresponding set of magnetic field measurement sensor data, e.g., sensor data 206-1. The magnetic field measurement sensor data can represent measurements from magnetic fields external to the satellite 104, such as magnetic fields of other objects in the extraterrestrial environment. The sensor system 204 also includes a second type of sensor, e.g., sensor 140-2, configured to process a sensor input of location information and generate a corresponding set of location measurement sensor data, e.g., sensor data 206-2.

The location measurement sensor data can represent location information about the satellite 104 and/or objects external to the satellite 104 in the extraterrestrial environment, such as other satellites and/or celestial bodies. The control system 142 can generate a control output 220 based on one or more types of sensor data, such as magnetic field sensor data, optical sensor data, imaging/image sensor data, and location/position sensor data. Alternatively, or additionally, the control system 142 can generate a control output 220 based on at least two different types of sensor data, e.g., magnetic field measurement data and location information, including combinations of other types of sensor data. The control output 220 is used to determine a magnetic field adjustment for the satellite 104 corresponding to a state vector adjustment. In this way, the control system 142 can rely on the Lorentz forces described in reference to FIG. 1C above to control and maneuver the satellite 104.

The control system 142 includes a control engine 214 that further includes one or more hardware processor 216 and control logic 218. The control logic 218 may be represented by executable instructions stored in an example non-transitory computer-readable medium, when executed by the hardware processor 216, cause the control engine 214 to perform one or more processes for controlling and maneuvering the satellite 104. The control engine 214 may be implemented using a combination of software and hardware, and specific aspects or operations of the control engine may be implemented in hardware, software, or both. The control engine 214 may, for example, be implemented as one or more hardware processors configured to execute one or more algorithms, as described in further detail below.

The hardware processor 216 may include one or more processors, such as general-purpose processors (e.g., a microprocessor), special-purpose processors (e.g., an application-specific integrated circuit (ASIC) or digital-signal processor (DSP)), programmable-logic devices (e.g., a field programmable gate array (FPGA)), or any other processor components. The hardware processor 216 may carry out one or more instructions using one or more arithmetic, logical, and/or input/output operations. Though the hardware processor 216 is illustrated as a single component, the hardware processor 216 may be integrated in whole or in part with other components of the control system 142.

The control engine 214 includes one or more ML inference accelerators 217 that are each configured to implement one or more AI/ML models 210. In the example of FIG. 2A, the satellite module 104 can include N inference accelerators 217, where N is an integer greater than or equal to one. In some implementations, the ML inference accelerator(s) 217 is an example inference processor integrated at the ML hardware layer 134 of satellite module 104.

The ML inference accelerator(s) 217 can be a special-purpose hardware integrated circuit, such as a hardware accelerator, hardware neural processor, neural network processor, or tensor processing unit (“TPU”). The ML inference accelerator(s) 217 are configured to execute ML computations on operand pairs that include an ML input(s) and a corresponding parameter(s). For example, the inference accelerator(s) 217 includes a computational (or linear) unit with arithmetic circuitry configured for a range of numerical operations, such as multiplication, addition, exponent arithmetic, and normalized addition. In some implementations, the inference accelerator(s) 217 include a matrix computation unit arranged as a systolic array of individual multiplier-accumulator cells (MACs). For example, the systolic array can be 32×32, 64×64, or 128×128 array of cells.

In some implementations, the AI/ML models 210 are neural network models that employ layers of nodes, including hidden layers, to generate an output, e.g., a classification, for a received input. For example, a layer of the neural network can generate an output from a received input in accordance with current values of a respective set of parameters. In some implementations, the AI/ML models 210 include convolutional neural networks (CNNs) configured to apply kernels, or transformers configured to apply attention-based mechanisms, to generate a classification output. Different types of neural network architectures can be used to perform a variety of tasks related to classification, pattern recognition, predictive data modeling, and information clustering.

As an example, the corresponding layers of the CNNs can have an associate set of kernels, which may correspond to parameters or weights. The associated set of kernels are used to process inputs (e.g., a batch of inputs) through the neural network layer to generate a corresponding output of the layer for computing a neural network inference. A batch of inputs and a set of kernels can be represented as a vector or matrix of inputs and weights. A batch of inputs and a set of kernels can also be represented as a tensor (n-rank), e.g., a multidimensional array, of inputs and weights. The inputs can be data values derived from the sensor inputs 202 (and sensor data 206), that are particularly relevant for generating certain types of control outputs.

For example, the data values can be magnetic field data values and multidimensional location data values, including related time series data. In some implementations, the magnetic field values are processed at a first AI/ML model 210 that is trained, such as by iteratively optimizing the model, to generate orbital velocity vectors (e.g., output 220-1) for controlling an orbital state of the satellite module 104, whereas the multidimensional location data values are processed at a second AI/ML model 210 that is trained, such as by iteratively optimizing the model, to generate orbital position vectors (e.g., output 220-2) for controlling the orbital state of the satellite module 104.

As described above, the AI/ML model(s) 210 can be configured to generate a control output based on sensor data 206, by applying trained predictive techniques. For example, the AI/ML models 210 can be trained to apply predictive analytics and related statistical techniques, which can include the neural networks described above as well as logistic and linear regression models, and decision trees. The control engine 214 includes a model trainer 212 for training different AI/ML models 210 implemented on the satellite module 104.

The model trainer 212 can use a variety of training techniques to train and selectively deploy different types of AI/ML models 210. In some implementations, the model trainer 212 dynamically applies different training technique based on the type and size of the data being processed as well as the predictive outputs that are of interest to a user. In general, the model trainer 212 can apply training techniques such as supervised learning, unsupervised learning, semi-supervised learning, self-supervised learning, and reinforcement learning, among others.

In some implementations, the control engine 214, via the model trainer 212, is configured to determine or otherwise select a particular ML algorithm for a corresponding training technique. For example, the model trainer 212 can dynamically select from one or more regression, classification, random forest, or neural network algorithms in response to determining to apply a supervised learning technique to train and deploy a first ML model 210. Similarly, the model trainer 212 can dynamically select from one or more data clustering algorithms in response to determining to apply unsupervised learning techniques to train and deploy a second ML model 210. For example, the model trainer 212 can select and use one or more of K-means clustering, hierarchical clustering, or probabilistic clustering algorithms to analyze data points for orbital paths of a group of satellite modules 104. Based on analyzing data points for orbital paths for a group of satellite modules, the model trainer 212 can then generate and deploy a second ML model 210 that generates predicted orbital adjustments to increase, e.g., maximize, solar energy collection. For example, the second ML model 210 can be configured to generate, based on the analyzed data points adjustments to an orbital path that increase an amount of time where the sun-facing side of the satellite faces a solar source, e.g., to improve solar energy collection. Additionally, the model trainer 212 can dynamically select from certain pretext (or predictive) learning algorithms in response to determining to apply self-supervised learning techniques to iteratively optimize the second ML model 210 or to train and deploy a third ML model 210. For example, the model trainer 212 can select pretext learning algorithms and generate the third ML model 210 based on analysis of location & image data of orbital distances between different satellites as well as optical link signal strength indicators (e.g., received signal strength indicator (RSSI)) performed using the pretext learning algorithms. The third ML model 210 can be configured to generate (e.g., compute) control outputs that optimize optical link signal integrity for improved inter-satellite connectivity and communications along a range of orbital trajectories. In this example, the pretext learning algorithm can enable the third ML model 210 to learn one part of the input (e.g., control outputs or RSSI values) from another part (e.g., location & image data of orbital distances), automatically generating labels and transforming unsupervised problems into supervised ones.

In some implementations, the model trainer 212 is configured to train (or generate) and deploy multiple different ML models 210 based on a variety of training techniques and ML algorithms that are applied to ground station data 242. The ground station data 242 can include a variety of labelled and unlabeled datasets received from ground station 163. In some implementations, a group of satellite modules can be dynamically configured to implement or mimic distributed computing and model training functions that are applied in terrestrial datacenters to train and deploy various AI/ML models.

The AI/ML model 210 can be trained according to different mission types for the satellite using sensor data collected by sensors of the satellite. For example, the AI/ML model 210 can be trained using magnetic field measurement data and location data of other objects to generate control outputs to improve orbiting and maneuvering for the satellite. As another example, the control outputs can be generated to improve solar energy collection and conversion to electric power for performing inference operations, e.g., one or more ML inference accelerators 217. The control adjustments can allow for maneuvers, orbits, attitude control and other types of satellite control for the satellite using a sensor-based modeling approach that accounts for the environment of the satellite.

The AI/ML model 210 can be trained on historical sensor data and provide control outputs more efficiently, e.g., training the model according to a number of iterations and penalty parameters to achieve real-time control output generate and control adjustment. The AI/ML model 210 can also be trained to identify patterns in state estimation that are based on environmental conditions that are unmodeled or unaccounted for by physics-based models. In some cases, the AI/ML model 210 can be trained to reduce sensitivity to noise in sensor measurement data, thereby reducing the effect of noise in generating control outputs for controlling the satellite. The AI/ML model 210 can also be trained to identify energy efficient maneuvers, orbits, orientations, etc., based on a type of mission or mission profile of the satellite, such as solar energy collection and conversion, ML training, ML inference, or a combination of these satellite mission types.

In some implementations, maneuvering the satellite can include applying controls to adjust the orbit and/or on-board operations in response to detecting a failure or fault condition of the satellite. For example, a control system of the satellite can detect a fault associated with components of a satellite subsystem, such as a photovoltaic cell of the solar panel layer, an inference accelerator, neural network processor, or tensor processor of the ML hardware layer, or heat transfer element of the heat dissipation layer. The control system can detect a fault condition in a component of the satellite and determine an action or adjustment to resolve the fault or to mitigate adverse effects to the satellite system as a result of the fault. For example, the control system can adjust the satellite's orbit to resolve the existing fault and mitigate occurrence of additional faults. Additionally, or alternatively, the control system can also perform other actions and control maneuvers to mitigate other types of damage to the affected satellite component and/or other satellite components.

Adjusting the satellite's orbit can include the control system of the faulty satellite (e.g., satellite with the component experiencing the detected fault) applying maneuvers to de-orbit the satellite. In some implementations, other satellites in proximity to the affected satellite (e.g., neighboring the affected satellite, within a threshold range of the affected satellite) can apply currents, e.g., by the respective control systems and/or control adjustment systems, to generate magnetic dipole forces that can be applied to the affected satellite. In this way, the satellites in proximity to the affected satellite can generate magnetic dipole forces external to the affected satellite, to cause adjustment to the affected satellite's orbit, orientation, or trajectory. In some cases, satellites in proximity to the affected satellite will defer to satellites that are configured to apply a magnetic force (e.g., individually or collectively) to affect a change in the orbit, orientation, or trajectory of the affected satellite. This action can also be performed to move and/or de-orbit the affected satellite.

In some implementations, the model trainer 212 can adjust a penalty parameter of a loss function for a model, such as to prevent overfitting when training the model. The model trainer 212 can adjust the penalty parameter to control a degree of regularization when generating the weights for the models, e.g., for training the model. The parameters adjusted in the AI/ML model 210 (e.g., networks, classifiers) can be learned e.g., by a neural network. In some implementations, adjusted model parameters can include coefficients or weights of a neural network, biases of a neural network, and cluster centroids in clustering networks. In some implementations, hyperparameters, e.g., parameters to adjust learning of the AI/ML model 210, can be adjusted for training the models. Hyperparameters may include a test-train split ratio, learning rates, selection of optimization algorithms, selection of functions, a number of hidden layers, a dropout rate, a number of iterations, a number of clusters, a pooling size, a batch size, and a kernel or filter size in convolutional layers. The selection of functions can include selecting one or more activation functions, cost functions, or loss functions.

In some implementations, the control engine 214 also optionally includes a physics-based model 215 (“physics model 215”) to generate a control output based on sensor data 206 by applying physics-based deterministic solvers, equations, or both equations and solvers. In some cases, the physics-based model 215 can include a model, or a combination of models, that apply various types of Kalman filters. In some cases, the physics-based model 215 can be one or more of Keplerian orbital models, perturbations models, atmospheric drag models, solar radiation pressure models, dynamics models, among other types of physics-based simulators or models.

The control engine 214 can be configured to generate a control output using one or both of the AI/ML model 210 and the physics model 215. For example, the control engine 214 can generate multiple control outputs using the same model (e.g., AI/ML model 210 or physics model 215) and determine a rate of change in state of the satellite 104 based on the control outputs. The control engine 214 can determine when to switch between models to maintain or improve accuracy of state estimation for the satellite 104, such as the rate of change in state meeting a threshold value, e.g., above the threshold value, below the threshold value. In another example, the control engine 214 can be configured to compare control outputs from both of the models 210 and 215 and determine an error value, such as by determining a mean square error or another type of metric, e.g., based on covariance values for an object's state vector. The control engine 214 can apply the control output with a lower error value. In some implementations, the control engine 214 can be configured to generate control outputs 220 for other components of the control adjustment system 214, such as an amount and direction of thrust for the thrusters 232 or an amount and direct of actuation by the actuators 226. In another example, the control outputs 220 can also include information for timing and deployment of solar sails 228. In another example, the control outputs can include information for actuation by the CMGs 230.

In some implementations, the control system 142 can generate the control outputs 220 based on a ground station signal 238 provided by a ground station, e.g., ground station 163 described in reference to FIG. 1D above. For example, the satellite 104 can include a transceiver 240 configured for communication between the satellite and the ground station 163. The transceiver 240 of the satellite 104 can process data from the ground station signal 238 to generate ground station data 242 for the control system 142. For example, the ground station signal 238 can include ground-based measurements of magnetic field measurements, positional information, infrared measurements, and other types of data that may be captured by sensors 204.

In some cases, the ground station signal 238 can include data for processing by the ML hardware layer 134 to perform machine learning training and/or inference tasks. In some implementations, the transceiver 240 can be configured to transmit data to a ground station and/or other satellites. For example, the transceiver 240 can be configured to transmit compute data from the ML hardware layer 134 such as outputs from machine learning models to a ground station. Although FIG. 2A depicts the transceiver 240 as receiving ground station signals, the transceiver 240 can be configured to transmit signals to the ground station. In some cases, the transceiver 240 can be configured to transmit sensor data such as positional information and magnetic field measurement data to another satellite 104. Further description of inter-satellite communication is described in reference to FIG. 2B below.

FIG. 2B is a block diagram 250 of a control system 142 for swarm control of multiple AI satellite modules 104. Similar to the control system 142 described in FIG. 2A, the control system 142 of FIG. 2B is an example of control between multiple satellites 104. For example, FIG. 2B depicts satellite module 104-1 communicatively coupled to a cluster 262 of satellites 104-2 through 104-N. The swarm depicted in FIG. 2B includes the satellite 104-1 and satellites 104-2 through 104-N. In some implementations, the swarm of satellites can be a subset of the satellites. For example, and as described in reference to FIG. 1D above, a cluster of satellites can include any number of satellites. Swarm control of the satellites can allow for complex maneuvers such as changes in relative position of one or more satellites relative to one or more other satellites in the swarm. In some instances, a swarm control function can include configuring the satellites to achieve a “bullwhip” acceleration of at least a subset of satellites, which can be performed to achieve relatively high velocities for complex and other maneuvers. In some instances, swarm control can include mission planning for satellites, such as station keeping of multiple satellites in the swarm relative to external objects, e.g., celestial objects.

The block diagram 250 shows satellite data 252-2 through 252-N from the multiple satellites 104-2 through 104-N being transmitted to the satellite module 104-1. For example, each satellite in the cluster 262 can provide a respective set of satellite data, e.g., satellite data 252-2 from satellite 104-2 and satellite data 252-N from satellite 104-N. The satellite data 252 can be communicated to the satellite 104-1 by communication system 254. The satellite 104-1 can be configured for communication and/or data transmission by the communication system 254 using free-space communication (e.g., optical, radio transmission) by optical connector 258. The satellite 104-1 can also be configured for communication and/or data transmission by the communication system 254 using physical connection (e.g., connecting signal pathways between satellites) by physical connector 256. The communication system 254 can provide data from any of the other satellites 104-2 through 104-N, including positional information, magnetic field measurement data, and other types of data to the control system 142. The control system 142 can be configured to generate a swarm control output for a second satellite different from the satellite 104-1, the control output indicating an adjustment of a magnetic force vector for the second satellite. For example, the control system 142 of satellite 104-1 can generate a swarm control output 260-2 for a satellite 104-2. Similarly, the control system 142 of satellite 104-1 can generate a swarm control output for multiple satellites, such as swarm control output 260-2 through 260-N corresponding to satellites 104-2 through 104-N.

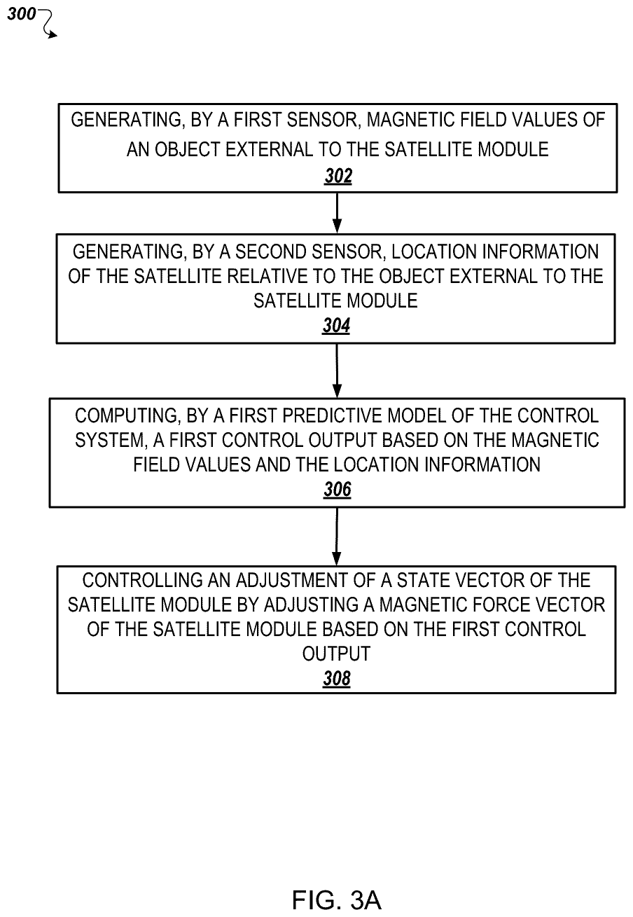

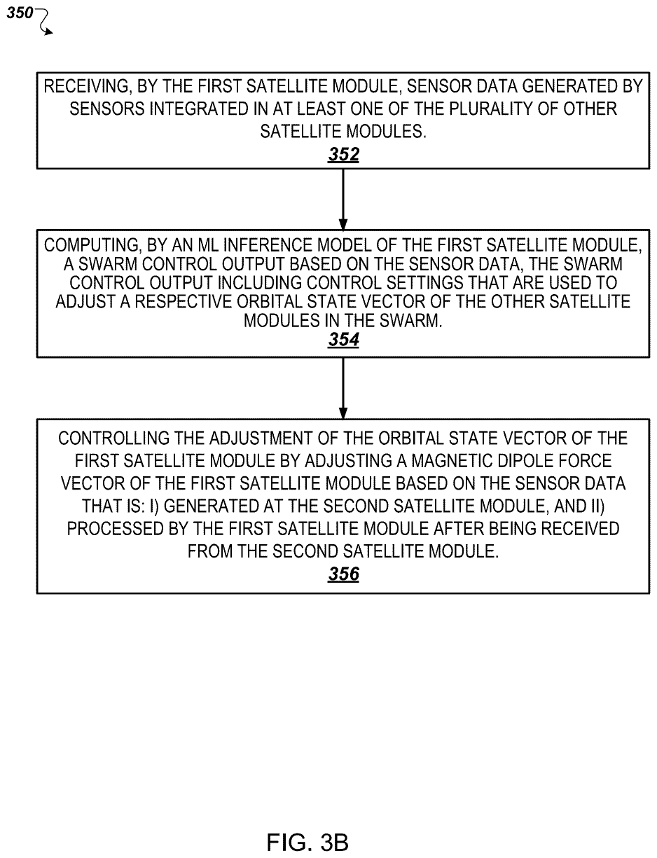

FIG. 3A shows an example process for individual control of an AI satellite module. Process 300 is also implemented or executed at satellite 104 using at least the control system 142 or the control adjustment system 144 described above with reference to FIGS. 2A and 2B. Hence, descriptions of process 300 will reference the above-mentioned computing resources of satellite 104. In some examples, the steps or actions of process 300 are enabled by programmed software instructions, firmware instructions, or both. Each type of instruction may be stored in a non-transitory machine-readable storage device and is executable by one or more of the processors or other resources described in this specification.

Referring again to process 300, the satellite 104 generates, by a first sensor, magnetic field values of an object external to the satellite module (302). For example, a sensor 140-1 of the satellite 104 can generate sensor data 206-1 for processing by the control system 142. In some implementations, the first sensor includes one or more of a magnetometer, a magneto-resistive sensor, a vector sensor, and an inductive sensor.

The satellite 104 generates, by a second sensor, location information of the satellite relative to the object external to the satellite module (304). In some implementations, the second sensor includes one or more of a star-tracker sensor, a sun-tracker sensor, imaging sensor, camera, and a Global Positioning System (GPS) sensor.

The satellite 104 computes, by a first predictive model of the control system, a first control output based on the magnetic field values and the location information (306).

In some implementations, the first predictive model is a machine-learning (“ML”) inference model and the process 300 includes processing, by the ML inference model, an input dataset including magnetic field values and location information about objects external to the satellite module. The process 300 includes generating control outputs based on ML inferences computed as outputs of the ML inference model in response to processing the input dataset by the ML inference model. The process 300 includes dynamically adjusting the orbital state vector of the satellite module based on the control outputs computed using the ML inference model.

In some implementations, the process 300 includes computing, by a physics-based model of the control system, a second control output based on a deterministic control algorithm of the physics-based model that receives the magnetic field values or the location information as inputs to the deterministic control algorithm. In some implementations, the physics-based model is configured to: i) process, using the deterministic control algorithm, on-board sensor data generated at the satellite module and image-based location information about objects external to the satellite module; and ii) compute a plurality of control outputs for adjusting the orbital state vector of the satellite module based on attitude estimations determined from processing the on-board sensor data and image-based location information.

The satellite 104 controls an orbital state vector of the satellite module by adjusting a magnetic dipole force vector of the satellite module based on the first control output (308). In some implementations, the first control output includes a predicted state vector for a particular time period for the satellite module based on data captured by the first sensor prior to the particular time period. In some implementations, the first control output includes a predicted state vector for a particular time period for the satellite module based on data captured by the second sensor prior to the particular time period.

In some implementations, the process 300 includes generating thrust by a directional thruster of the satellite module based on the first control output and controlling the orbital state vector of the satellite module based on the thrust generated by the directional thruster. In some implementations, the orbital state vector of the satellite module includes at least one of (i) an orbital position vector of the satellite module, and (ii) an orbital velocity vector of the satellite module.

In some implementations, the process 300 includes generating first control signals corresponding to the first control output and that are used to control an adjustment of the orbital state vector of the satellite module based on the magnetic field values and the location information. In some implementations, the process 300 includes deploying a solar sail of the satellite module based on the first control output and adjusting the orbital state vector of the satellite module using the solar sail, in response to deploying the solar sail. In some implementations, the process 300 includes configuring a vectoring component of the control system based on a timing parameter and a control instruction indicated by the first control output. The process 300 can include performing the adjustment of the orbital state vector in response to configuring the vectoring component based on the timing parameter and the control instruction. The vectoring component can include a reaction wheel and configuring the vectoring component can include configuring, using the first control output, one or more reaction wheels of the satellite module to spin at a speed corresponding to the adjustment of the magnetic dipole force vector. In some implementations, the first control output includes first control signals that further include instructions, e.g., commands to be performed by one or more components of the satellite module, and timing signals, e.g., indicating a timing to apply the command by the one or more components.

In some implementations, the process 300 includes generating, by the control system, a first current signal that corresponds to an adjustment of the magnetic dipole force vector. The first current signal can traverse a current loop path that is substantially parallel to a circumference of the satellite module. In some implementations, the process 300 includes generating, by a magnetorquer of the control system, a second current signal. The process 300 includes generating a counteracting magnetic dipole force vector, e.g., based on the second current signal, and controlling an attitude of the satellite module by mitigating excess angular momentum of the satellite module based on the counteracting magnetic dipole force vector.

In some implementations, the satellite module is part of a swarm including a plurality of satellite modules. The process 300 includes controlling a respective orbital state vector of each satellite module in the swarm. The process 300 includes configuring a swarm formation orbit by adjusting a respective magnetic dipole force vector of at least one satellite module of the swarm. The process 300 includes adjusting a configuration of the swarm formation orbit based on changes in magnetic field density of a celestial body orbited by the plurality of satellite modules of the swarm.

In some implementations, the process 300 includes detecting a difference between the first control output and the second control output in response to comparing the first and second control outputs. The process 300 includes identifying an inconsistency between respective orbital state vectors of the satellite module that correspond to the first and second control outputs based on the detected difference. The process 300 includes adjusting the orbital state vector of the satellite module based on prioritization logic that resolves the inconsistency in favor of control outputs computed by a particular model of the satellite module.

In some implementations, the process 300 includes receiving, from an external data source, data related to at least (i) the object external to the satellite module, or (ii) the satellite module. The process 300 includes computing, by the first predictive model of the control system, the first control output based on the external data.

In some implementations, the satellite module is a first satellite module that communicates with a second satellite module. The process 300 includes controlling the adjustment of the orbital state vector of the first satellite module by adjusting a magnetic dipole force vector of the first satellite module based on sensor data that is: i) generated at the second satellite module, and ii) processed by the first satellite module after being received from the second satellite module.

In some implementations, the first satellite module is part of a swarm including a plurality of other satellite modules. The process 300 includes receiving, by the first satellite module, sensor data generated by sensors integrated in at least one of the plurality of other satellite modules. The process 300 includes computing, by an ML inference model of the first satellite module, a swarm control output based on the sensor data. The swarm control output includes control settings that are used to adjust a respective orbital state vector of the other satellite modules in the swarm.

In some implementations, the satellite module is a planar, modular satellite configured for coupling to another planar, modular satellite.

FIG. 3B shows an example process 350 for swarm control of multiple AI satellite modules. Process 350 is also implemented or executed at satellite 104 using at least the control system 208 or control system 142 described above with reference to FIGS. 1B, 2A and 2B above. Hence, descriptions of process 350 will reference the above-mentioned computing resources of satellite 104. In some examples, the steps or actions of process 350 are enabled by programmed software instructions, firmware instructions, or both. Each type of instruction may be stored in a non-transitory machine-readable storage device and is executable by one or more of the processors or other resources described in this specification.

The satellite module can be a first satellite module that communicates with a second satellite module. The first satellite module can be part of a swarm that includes a plurality of other satellite modules.

The process 350 includes, receiving, by the first satellite module, sensor data generated by sensors integrated in at least one of the plurality of other satellite modules (352).

The process 350 includes, computing, by an ML inference model of the first satellite module, a swarm control output based on the sensor data (354). The swarm control output can include control settings that are used to adjust a respective orbital state vector of the other satellite modules in the swarm.

The process 350 includes, controlling the adjustment of the orbital state vector of the first satellite module by adjusting a magnetic dipole force vector of the first satellite module based on the sensor data (356). The sensor data is i) generated at the second satellite module, and ii) processed by the first satellite module after being received from the second satellite module (356).

In some implementations, the respective steps of process 300 and/or process 350 are performed by a hardware integrated circuit as part of a larger compute operation to generate a machine-learning (ML) output by the satellite 104, including an output for a neural network layer of a neural network that implements one or more ML models. For example, the output can be a portion of a computation for a ML task or inference workload to generate an image processing, speech processing, or image recognition output. As indicated above, a portion of the integrated circuit can include a special-purpose neural network processor or hardware ML accelerator configured to accelerate computations for generating different types of data processing outputs.

Embodiments of the subject matter and the functional operations described in this specification can be implemented in digital electronic circuitry, in tangibly-embodied computer software or firmware, in computer hardware, including the structures disclosed in this specification and their structural equivalents, or in combinations of one or more of them. Embodiments of the subject matter described in this specification can be implemented as one or more computer programs, i.e., one or more modules of computer program instructions encoded on a tangible non transitory program carrier for execution by, or to control the operation of, data processing apparatus.

Alternatively or in addition, the program instructions can be encoded on an artificially generated propagated signal, e.g., a machine-generated electrical, optical, or electromagnetic signal, that is generated to encode information for transmission to suitable receiver apparatus for execution by a data processing apparatus. The computer storage medium can be a machine-readable storage device, a machine-readable storage substrate, a random or serial access memory device, or a combination of one or more of them.

The term “computing system” encompasses all kinds of apparatus, devices, and machines for processing data, including by way of example a programmable processor, a computer, or multiple processors or computers. The apparatus can include special purpose logic circuitry, e.g., an FPGA (field programmable gate array) or an ASIC (application specific integrated circuit). The apparatus can also include, in addition to hardware, code that creates an execution environment for the computer program in question, e.g., code that constitutes processor firmware, a protocol stack, a database management system, an operating system, or a combination of one or more of them.

A computer program (which may also be referred to or described as a program, software, a software application, a module, a software module, a script, or code) can be written in any form of programming language, including compiled or interpreted languages, or declarative or procedural languages, and it can be deployed in any form, including as a stand-alone program or as a module, component, subroutine, or other unit suitable for use in a computing environment.

A computer program may, but need not, correspond to a file in a file system. A program can be stored in a portion of a file that holds other programs or data, e.g., one or more scripts stored in a markup language document, in a single file dedicated to the program in question, or in multiple coordinated files, e.g., files that store one or more modules, sub programs, or portions of code. A computer program can be deployed to be executed on one computer or on multiple computers that are located at one site or distributed across multiple sites and interconnected by a communication network.

The processes and logic flows described in this specification can be performed by one or more programmable computers executing one or more computer programs to perform functions by operating on input data and generating output. The processes and logic flows can also be performed by, and apparatus can also be implemented as, special purpose logic circuitry, e.g., an FPGA (field programmable gate array), an ASIC (application specific integrated circuit), or a GPU (General purpose graphics processing unit).

Computers suitable for the execution of a computer program include, by way of example, can be based on general or special purpose microprocessors or both, or any other kind of central processing unit. Generally, a central processing unit will receive instructions and data from a read only memory or a random-access memory or both. Some elements of a computer are a central processing unit for performing or executing instructions and one or more memory devices for storing instructions and data. Generally, a computer will also include, or be operatively coupled to receive data from or transfer data to, or both, one or more mass storage devices for storing data, e.g., magnetic, magneto optical disks, or optical disks. However, a computer need not have such devices.

Computer readable media suitable for storing computer program instructions and data include all forms of nonvolatile memory, media and memory devices, including by way of example semiconductor memory devices, e.g., EPROM, EEPROM, and flash memory devices; magnetic disks, e.g., internal hard disks or removable disks; magneto optical disks; and CD ROM and DVD-ROM disks. The processor and the memory can be supplemented by, or incorporated in, special purpose logic circuitry.

To provide for interaction with a user, embodiments of the subject matter described in this specification can be implemented on a computer having a display device, e.g., LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's client device in response to requests received from the web browser.

Embodiments of the subject matter described in this specification can be implemented in a computing system that includes a back end component, e.g., as a data server, or that includes a middleware component, e.g., an application server, or that includes a front end component, e.g., a client computer having a graphical user interface or a Web browser through which a user can interact with an implementation of the subject matter described in this specification, or any combination of one or more such back end, middleware, or front end components. The components of the system can be interconnected by any form or medium of digital data communication, e.g., a communication network. Examples of communication networks include a local area network (“LAN”) and a wide area network (“WAN”), e.g., the Internet.

The computing system can include clients and servers. A client and server are generally remote from each other and typically interact through a communication network. The relationship of client and server arises by virtue of computer programs running on the respective computers and having a client-server relationship to each other.

While this specification contains many specific implementation details, these should not be construed as limitations on the scope of any invention or of what may be claimed, but rather as descriptions of features that may be specific to particular embodiments of particular inventions. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system modules and components in the embodiments described above should not be understood as requiring such separation in all embodiments, and it should be understood that the described program components and systems can generally be integrated together in a single software product or packaged into multiple software products.

Particular embodiments of the subject matter have been described. Other embodiments are within the scope of the following claims. For example, the actions recited in the claims can be performed in a different order and still achieve desirable results. As one example, the processes depicted in the accompanying figures do not necessarily require the particular order shown, or sequential order, to achieve desirable results. In certain implementations, multitasking and parallel processing may be advantageous.

What is claimed is:

1. A control system for a satellite module, the control system comprising:
a first sensor configured to generate magnetic field values of an object external to the satellite module;
a second sensor configured to generate location information of the satellite module relative to the object external to the satellite module; and
a first predictive model configured to compute a first control output based on the magnetic field values and the location information; and
wherein the control system is configured to control an adjustment of an orbital state vector of the satellite module by adjusting a magnetic dipole force vector of the satellite module based on the first control output.

2. The control system of claim 1, wherein the orbital state vector of the satellite module comprises at least one of (i) an orbital position vector of the satellite module, and (ii) an orbital velocity vector of the satellite module.

3. The control system of claim 2, wherein the control system is configured to:
deploy a solar sail of the satellite module based on the first control output; and
adjust the orbital state vector of the satellite module using the solar sail, in response to deploying the solar sail.

4. The control system of claim 2, wherein the control system is configured to:
configure a vectoring component of the control system based on a timing parameter and a control instruction indicated by the first control output; and
perform the adjustment of the orbital state vector in response to configuring the vectoring component based on the timing parameter and the control instruction.

5. The control system of claim 2, wherein the control system is further configured to generate a first current signal that corresponds to an adjustment of the magnetic dipole force vector, wherein the first current signal traverses a current loop path that is substantially parallel to a circumference of the satellite module.

6. The control system of claim 4, wherein the vectoring component comprises a reaction wheel and configuring the vectoring component comprises:
configuring, using the first control output, the reaction wheel to spin at a speed corresponding to the adjustment of the magnetic dipole force vector.

7. The control system of claim 6, wherein the control system is configured to:
generate, by a magnetorquer of the control system, a second current signal;
generate a counteracting magnetic dipole force vector based on the second current signal; and
control an attitude of the satellite module by mitigating excess angular momentum of the satellite module based on the counteracting magnetic dipole force vector.

8. The control system of claim 1, wherein the first predictive model is a machine-learning (“ML”) inference model configured to:
process an input dataset comprising magnetic field values and location information about objects external to the satellite module;
generate control outputs based on ML inferences computed as outputs of the ML inference model in response to processing the input dataset; and
dynamically adjust the orbital state vector of the satellite module based on the control outputs.

9. The control system of claim 1, wherein the control system is configured to:
compute, by a physics-based model, a second control output based on a deterministic control algorithm of the physics-based model that receives the magnetic field values or the location information as inputs to the deterministic control algorithm.

10. The control system of claim 9, wherein the physics-based model is configured to:
i) process, using the deterministic control algorithm, on-board sensor data generated at the satellite module and image-based location information about objects external to the satellite module; and
ii) compute a plurality of control outputs for adjusting the orbital state vector of the satellite module based on attitude estimations determined from processing the on-board sensor data and image-based location information.

11. The control system of claim 10, further comprising:
detect a difference between the first control output and the second control output in response to comparing the first and second control outputs;
based on the detected difference, identify an inconsistency between respective orbital state vectors of the satellite module that correspond to the first and second control outputs; and
adjust the orbital state vector of the satellite module based on prioritization logic that resolves the inconsistency in favor of control outputs computed by a particular model of the satellite module.

12. The control system of claim 1, wherein the control system is configured to:
receive, from an external data source, data related to at least (i) the object external to the satellite module, or (ii) the satellite module; and
compute, by the first predictive model of the control system, the first control output based on the external data.

13. The control system of claim 1, wherein the satellite module is a first satellite module that communicates with a second satellite module, and wherein the control system is configured to:
control the adjustment of the orbital state vector of the first satellite module by adjusting a magnetic dipole force vector of the first satellite module based on sensor data that is:
i) generated at the second satellite module, and
ii) processed by the first satellite module after being received from the second satellite module.

14. The control system of claim 13, wherein the first satellite module is part of a swarm comprising a plurality of other satellite modules and the control system is configured to:
receive, by the first satellite module, sensor data generated by sensors integrated in at least one of the plurality of other satellite modules; and
compute, by an ML inference model of the first satellite module, a swarm control output based on the sensor data,
wherein the swarm control output comprises control settings that are used to adjust a respective orbital state vector of the other satellite modules in the swarm.

15. The control system of claim 1, wherein the satellite module is a planar, modular satellite configured for coupling to another planar, modular satellite.

16. The control system of claim 1, wherein the first control output comprises a predicted state vector for a particular time period for the satellite module based on data captured by the first sensor prior to the particular time period.

17. The control system of claim 1, further comprising:
a connector configured to communicatively couple the satellite module to a first satellite module different from the satellite module.

18. The control system of claim 17, wherein the connector is a physical connector for connection to another physical connector of another satellite module.

19. The control system of claim 17, wherein the connector is an optical inter-satellite connector comprises one or more actuators and a lens, wherein the one or more actuators are configured to adjust an angle of the lens for free-space communication with another optical inter-satellite connector of another satellite module.

20. The control system of claim 1, wherein the satellite module comprises a thruster subsystem and wherein the control system is configured to adjust the magnetic dipole force vector of the satellite module by generating, using the thruster subsystem, an amount of thrust based on the first control output.

21. The control system of claim 1, wherein the first sensor comprises one or more of a magnetometer, a magneto-resistive sensor, a vector sensor, and an inductive sensor.

22. The control system of claim 1, wherein the second sensor comprises one or more of a star-tracker sensor, a sun-tracker sensor, imaging sensor, camera, and a Global Positioning System (GPS) sensor.

23. The control system of claim 1, wherein adjusting the magnetic dipole force vector of the satellite module comprises the control system configured to:
generate thrust by a directional thruster of the satellite module based on the first control output; and
control the orbital state vector of the satellite module based on the thrust generated by the directional thruster.

24. The control system of claim 1, wherein the satellite module is part of a swarm comprising a plurality of satellite modules and the control system is configured to:
control a respective orbital state vector of each satellite module in the swarm;
configure a swarm formation orbit by adjusting a respective magnetic dipole force vector of at least one satellite module of the swarm; and
adjust a configuration of the swarm formation orbit based on changes in magnetic field density of a celestial body orbited by the plurality of satellite modules of the swarm.

25. A non-transitory machine-readable storage device for storing instructions used to control a satellite module, the instructions being executable by a control system of the satellite module to cause performance of operations comprising:
generating, by a first sensor, magnetic field values of an object external to the satellite module;
generating, by a second sensor, location information of the satellite module relative to the object external to the satellite module;
computing, by a first predictive model of the control system, a first control output based on the magnetic field values and the location information; and
controlling an orbital state vector of the satellite module by adjusting a magnetic dipole force vector of the satellite module based on the first control output.

26. The non-transitory machine-readable storage device of claim 25, wherein the orbital state vector of the satellite module comprises at least one of (i) an orbital position vector of the satellite module, and (ii) an orbital velocity vector of the satellite module.

27. The non-transitory machine-readable storage device of claim 25, the operations further comprising:
generating first control signals corresponding to the first control output and that are used to control an adjustment of the orbital state vector of the satellite module based on the magnetic field values and the location information.

28. The non-transitory machine-readable storage device of claim 27, the operations further comprising:
deploying a solar sail of the satellite module based on the first control output; and
adjusting the orbital state vector of the satellite module using the solar sail, in response to deploying the solar sail.

29. The non-transitory machine-readable storage device of claim 27, the operations further comprise:
configuring a vectoring component of the control system based on a timing parameter and a control instruction indicated by the first control output; and
performing the adjustment of the orbital state vector in response to configuring the vectoring component based on the timing parameter and the control instruction.

30. The non-transitory machine-readable storage device of claim 27, the operations further comprising:
generating, by the control system, a first current signal that corresponds to an adjustment of the magnetic dipole force vector,
wherein the first current signal traverses a current loop path that is substantially parallel to a circumference of the satellite module.

31. The non-transitory machine-readable storage device of claim 29, wherein the vectoring component comprises a reaction wheel and configuring the vectoring component comprises:
configuring, using the first control output, one or more reaction wheels of the satellite module to spin at a speed corresponding to the adjustment of the magnetic dipole force vector.

32. The non-transitory machine-readable storage device of claim 31, the operations further comprise:
generating, by the control system, a second current signal;
generating, using a magnetorquer and based on the second current signal, a counteracting magnetic dipole force vector; and
controlling an attitude of the satellite module by mitigating excess angular momentum of the satellite module based on the counteracting magnetic dipole force vector.

33. The non-transitory machine-readable storage device of claim 25, wherein the first predictive model is a machine-learning (“ML”) inference model and the operations further comprise:
processing, by the ML inference model, an input dataset comprising magnetic field values and location information about objects external to the satellite module;
generating control outputs based on ML inferences computed as outputs of the ML inference model in response to processing the input dataset by the ML inference model; and
dynamically adjusting the orbital state vector of the satellite module based on the control outputs computed using the ML inference model.

34. The non-transitory machine-readable storage device of claim 25, the operations further comprising:
computing, by a physics-based model of the control system, a second control output based on a deterministic control algorithm of the physics-based model that receives the magnetic field values or the location information as inputs to the deterministic control algorithm.

35. The non-transitory machine-readable storage device of claim 34, wherein the physics-based model is configured to:
i) process, using the deterministic control algorithm, on-board sensor data generated at the satellite module and image-based location information about objects external to the satellite module; and
ii) compute a plurality of control outputs for adjusting the orbital state vector of the satellite module based on attitude estimations determined from processing the on-board sensor data and image-based location information.

36. The non-transitory machine-readable storage device of claim 34, the operations further comprising:
detecting a difference between the first control output and the second control output in response to comparing the first and second control outputs;
based on the detected difference, identifying an inconsistency between respective orbital state vectors of the satellite module that correspond to the first and second control outputs; and
adjusting the orbital state vector of the satellite module based on prioritization logic that resolves the inconsistency in favor of control outputs computed by a particular model of the satellite module.

37. The non-transitory machine-readable storage device of claim 25, the operations further comprising:
receiving, from an external data source, data related to at least (i) the object external to the satellite module, or (ii) the satellite module; and
computing, by the first predictive model of the control system, the first control output based on the external data.

38. The non-transitory machine-readable storage device of claim 25, wherein the satellite module is a first satellite module that communicates with a second satellite module, and the operations further comprise:
controlling the adjustment of the orbital state vector of the first satellite module by adjusting a magnetic dipole force vector of the first satellite module based on sensor data that is:
i) generated at the second satellite module, and
ii) processed by the first satellite module after being received from the second satellite module.

39. The non-transitory machine-readable storage device of claim 38, wherein the first satellite module is part of a swarm comprising a plurality of other satellite modules and the operations further comprise:
receiving, by the first satellite module, sensor data generated by sensors integrated in at least one of the plurality of other satellite modules; and
computing, by an ML inference model of the first satellite module, a swarm control output based on the sensor data,
wherein the swarm control output comprises control settings that are used to adjust a respective orbital state vector of the other satellite modules in the swarm.

40. The non-transitory machine-readable storage device of claim 25, wherein the satellite module is a planar, modular satellite configured for coupling to another planar, modular satellite.

41. The non-transitory machine-readable storage device of claim 25, wherein the first control output comprises a predicted state vector for a particular time period for the satellite module based on data captured by the first sensor prior to the particular time period.

42. The non-transitory machine-readable storage device of claim 25, wherein the first control output comprises a predicted state vector for a particular time period for the satellite module based on data captured by the second sensor prior to the particular time period.

43. The non-transitory machine-readable storage device of claim 25, wherein the first sensor comprises one or more of a magnetometer, a magneto-resistive sensor, a vector sensor, and an inductive sensor.

44. The non-transitory machine-readable storage device of claim 25, wherein the second sensor comprises one or more of a star-tracker sensor, a sun-tracker sensor, imaging sensor, camera, and a Global Positioning System (GPS) sensor.

45. The non-transitory machine-readable storage device of claim 25, the operations further comprising:
generating thrust by a directional thruster of the satellite module based on the first control output; and
controlling the orbital state vector of the satellite module based on the thrust generated by the directional thruster.

46. The non-transitory machine-readable storage device of claim 45, wherein the satellite module is part of a swarm comprising a plurality of satellite modules and the operations further comprise:
controlling a respective orbital state vector of each satellite module in the swarm;
configuring a swarm formation orbit by adjusting a respective magnetic dipole force vector of at least one satellite module of the swarm; and
adjusting a configuration of the swarm formation orbit based on changes in magnetic field density of a celestial body orbited by the plurality of satellite modules of the swarm.

47. The non-transitory machine-readable storage device of claim 25, the operations further comprising:
generating, by the first sensor, second magnetic field values of a plurality of objects external to the satellite module; and
computing, by the first predictive model of the control system, a control output based on the second magnetic field values and the location information; and
controlling the orbital state vector of the satellite module by adjusting a magnetic dipole force vector of the satellite module based on the control output.

48. The non-transitory machine-readable storage device of claim 25, wherein adjusting the magnetic dipole force vector of the satellite module based on the first control output comprises adjusting operation of an actively-generated magnetic field of the satellite module.

49. A method implemented using a control system of a satellite module, the method comprising:
generating, by a first sensor, magnetic field values of an object external to the satellite module;
generating, by a second sensor, location information of the satellite module relative to the object external to the satellite module;
computing, by a first predictive model of the control system, a first control output based on the magnetic field values and the location information; and
controlling an orbital state vector of the satellite module by adjusting a magnetic dipole force vector of the satellite module based on the first control output.
